(19) United States
(12) Patent Application Publication
(10) Pub. No.: US 2011/0267634 A1
(43) Pub. Date: Nov. 3, 2011

(54) IMAGE FORMING APPARATUS, IMAGE FORMING METHOD, AND COMPUTER-READABLE RECORDING MEDIUM

(75) Inventors: Kaoru FUKUOKA, Toyokawa-shi (JP); Kana Kodama, Anjo-shi (JP); Shoji Imaizumi, Shinshiro-shi (JP); Yoichi Kurumasa, Toyokawa-shi (JP)

(73) Assignee: Konica Minolta Business Technologies, Inc., Chiyoda-ku (JP)

(21) Appl. No.: 13/089,821

(22) Filed: Apr. 19, 2011

(30) Foreign Application Priority Data
Apr. 30, 2010 (JP) 2010-104833

(51) Int. Cl. G06F 3/12

(52) U.S. Cl. 358/1.13; 358/1.15

(57) ABSTRACT

An image forming apparatus includes a creation unit that creates a preview image showing a print output state regarding a target image of printing processing, and an input/output unit that displays a screen including a preview display region as a display region of the preview image and a re-set item display region as a display region of a menu image having a setting item for re-set regarding the printing processing, and accepts a setting change input regarding the setting item for the re-set in the menu image. The creation unit recreates the preview image based on setting contents after a setting change, the setting contents being accepted with regard to the setting item for the re-set. The input/output unit displays the recreated preview image on the preview display region.

This application is based on Japanese Patent Application No. 2010-104833 filed on Apr. 30, 2010, the contents of which are hereby incorporated by reference.

### BACKGROUND OF THE INVENTION

1. Field of the Invention

The present invention relates to an image forming apparatus such as a multi-function peripheral (MFP).

2. Description of the Related Art

In an image forming apparatus such as an MFP, there is a technology for previewing image data before printing and outputting the image data.

For example, Japanese Patent Laid-Open Application No. 2010-34844 (hereinafter, referred to as Patent Document 1) describes a technology for previewing the image data before test print thereof. In detail, in the technology of Patent Document 1, an image (preview display screen) for the preview, which is created based on the image data, is displayed on a display unit (touch panel) of the image forming apparatus, and confirmation before the print and output of the image data is performed by the image for the preview.

Incidentally, the image data being previewed is sometimes required to undergo a setting change as a result of confirming the preview image thereof. Therefore, it is preferable that the image data be capable of undergoing a re-set operation regarding the print and output thereof.

For example, in the technology described in Patent document 1, it is described that the re-set operation is performed for the image data being previewed.

However, in the re-set operation described in Patent Document 1, a re-set button arranged in the vicinity of a preview display screen is pressed down, whereby another screen (preview re-set screen) for the re-set is displayed on the touch panel in place of the preview display screen. Then, when a re-preview button in the preview re-set screen is pressed down after the re-set operation using the preview re-set screen is performed, then a (updated) preview display screen that is based on setting contents made after the re-set is displayed on the touch panel in place of the preview re-set screen.

Thus, screen transition in the touch panel is repeatedly executed. In particular, in a period while the preview re-set screen is being displayed on the touch panel, the preview display screen is not displayed on the touch panel, and at the time of the re-set operation, the preview display screen (preview image) cannot be visually recognized. Therefore, there is a problem that sufficient operability cannot be obtained.

### SUMMARY OF THE INVENTION

It is an object of the present invention to provide an image forming apparatus capable of obtaining high operability in the re-set operation after the preview, and to provide a technology related to the image forming apparatus.

A first aspect of the present invention provides an image forming apparatus including a creation unit that creates a preview image showing a print output state regarding a target image of printing processing, and an input/output unit that displays a screen including a preview display region which is a display region of the preview image and a re-set item display region which is a display region of a menu image having a setting item for re-set regarding the printing processing, and accepts a setting change input regarding the setting item for the re-set in the menu image. The creation unit recreates the preview image based on setting contents after a setting change, the setting contents being accepted with regard to the setting item for the re-set. The input/output unit displays the recreated preview image on the preview display region.

A second aspect of the present invention provides an image forming method including the steps of a) creating a preview image showing a print output state regarding a target image of printing processing, b) displaying a screen including a preview display region which is a display region of the preview image and a re-set item display region which is a display region of a menu image having a setting item for re-set regarding the printing processing, c) accepting a setting change input regarding the setting item for the re-set in the menu image, d) recreating the preview image based on setting contents after a setting change, the setting contents being accepted with regard to the setting item for the re-set, and e) displaying the recreated preview image on the preview display region.

A third aspect of the present invention provides a computer-readable recording medium storing a computer program for performing the steps of a) creating a preview image showing a print output state regarding a target image of printing processing, b) displaying a screen including a preview display region which is a display region of the preview image and a re-set item display region which is a display region of a menu image having a setting item for re-set regarding the printing processing, c) accepting a setting change input regarding the setting item for the re-set in the menu image, d) recreating the preview image based on setting contents after a setting change, the setting contents being accepted with regard to the setting item for the re-set, and e) displaying the recreated preview image on the preview display region.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a configuration of an image forming apparatus;

FIG. 2 is a flowchart showing a copy job;

FIG. 3 is a view showing a setting screen of an operation panel unit;

FIG. 4 is a setting screen for performing setting operations regarding “color”;

FIG. 5 is a setting screen for performing setting operations regarding “finish”;

FIG. 6 is a setting screen for performing setting operations regarding “staple”;

FIG. 7 is a view showing a screen including a preview image on which an initial setting is reflected;

FIG. 8 is a view showing a screen during a re-set operation;

FIG. 9 is a view showing a screen including the preview image after the re-set operation;

FIG. 10 is a view showing a screen on which “frame deletion” is registered as a bookmark;

FIG. 11 is a view showing a detailed menu image for re-set regarding “frame deletion”;

FIG. 12 is a view showing a preview image on which a setting change result is reflected;

FIG. 13 is a view showing a preview image on which a further setting change result is reflected;

FIG. 14 is a view showing a state where two exclusive setting items are registered as bookmarks (Second Embodiment);

FIG. 15 is a view showing a preview image on which a setting change result is reflected;

FIG. 16 is a display example according to a modification example;

FIG. 17 is a display example according to the modification example;

FIG. 18 is a view showing a menu screen on which bookmark items registered in the apparatus are displayed (Third Embodiment);

FIG. 19 is a view showing a preview image on which a setting change result is reflected;

FIG. 20 is a view showing a data table for registering bookmark items different for each of users in the apparatus;

FIG. 21 is a view showing a menu screen regarding a certain user;

FIG. 22 is a view showing a target print output state (Fourth Embodiment);

FIG. 23 is a view showing “orientation of original” mounted by the user;

FIG. 24 is a view showing “orientation of original” assumed by the image forming apparatus;

FIG. 25 is a view showing staple positions based on the assumption of the image forming apparatus;

FIG. 26 is a view showing superposition of FIG. 23 and FIG. 25;

FIG. 27 is a view showing a print and output result based on the assumption of the image forming apparatus;

FIG. 28 is a flowchart showing operations including a bookmark registration operation of automatic setting items;

FIG. 29 is a view showing a screen on which the automatic setting items are registered as “bookmark”;

FIG. 30 is a view showing a screen including an updated preview image;

FIG. 31 is a view showing a registration screen for classifying and registering the bookmark items based on usage expectation degrees (expected usage frequencies);

FIG. 32 is a view showing a screen on which a plurality of “bookmark items” are classified and registered based on “usage expectation degrees”;

FIG. 33 is a view showing a screen on which “resource saving promotion bookmark items” are displayed;

FIG. 34 is a view showing bookmark history information;

FIG. 35 is a view showing a screen on which “bookmark items” are called up by using the bookmark history information;

FIG. 36 is a view showing a preview image on which a setting change result is reflected;

FIG. 37 is a view showing a data table in which “bookmark usage information” is recorded;

FIG. 38 is a view showing a screen before a menu image is enlarged; and

FIG. 39 is a view showing a screen after the menu image is enlarged.

### DETAILED DESCRIPTION OF PREFERRED EMBODIMENTS

A description is given below of embodiments of the present invention with reference to the drawings.

### 1. First Embodiment

<1-1. Configuration>

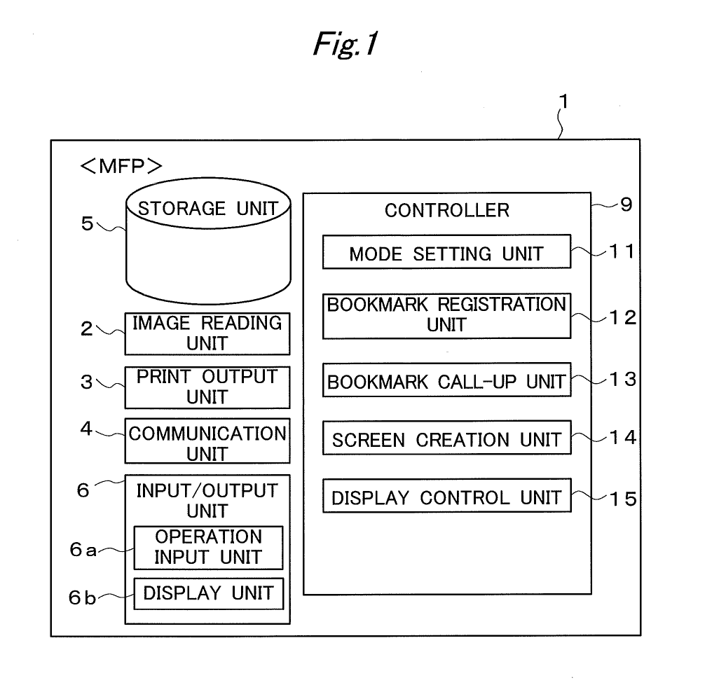

FIG. 1 is a schematic diagram showing a configuration of an image forming apparatus 1. Here, it is assumed that the image forming apparatus 1 is configured as a multi-function peripheral (also abbreviated as an MFP). The MFP is an apparatus (also referred to as a multi-function machine) provided with a scanner function, a printer function, a copier function, a facsimile communication function and the like. Note that the image forming apparatus 1 is not limited to the MFP, and may be configured as a copier apparatus and the like.

As shown in FIG. 1, the image forming apparatus 1 includes an image reading unit 2, a print output unit 3, a communication unit 4, a storage unit 5, an input/output unit 6, and a controller 9. The image forming apparatus 1 operates these respective units in combination with one another, and thereby realizes respective functions.

The image reading unit 2 is a processing unit that optically reads an original mounted on a predetermined position of the image forming apparatus 1, and creates image data (also referred to as an original image) of the original.

The print output unit 3 is an output unit that prints and outputs an image on a variety of media such as paper based on the image data regarding such a target image.

The communication unit 4 is a processing unit capable of performing facsimile communication through public lines and the like. Moreover, the communication unit 4 is capable of network communication through a network NW. In this network communication, a variety of protocols such as Transmission Control Protocol/Internet Protocol (TCP/IP) and File Transfer Protocol (FTP) are used, and use of the network communication enables the image forming apparatus 1 to transfer a variety of data with desired destinations.

The storage unit 5 is composed of a storage device such as a hard disk drive (HDD) and a non-volatile memory. In this storage unit 5, there are stored the original image (image data) created by the image reading unit 2 or the like, and the like. Moreover, various pieces of history information and the like are also stored in the storage unit 5.

The input/output unit 6 includes an operation input unit 6a that receives an input to the image forming apparatus 1, and a display unit 6b that performs display output of various pieces of information.

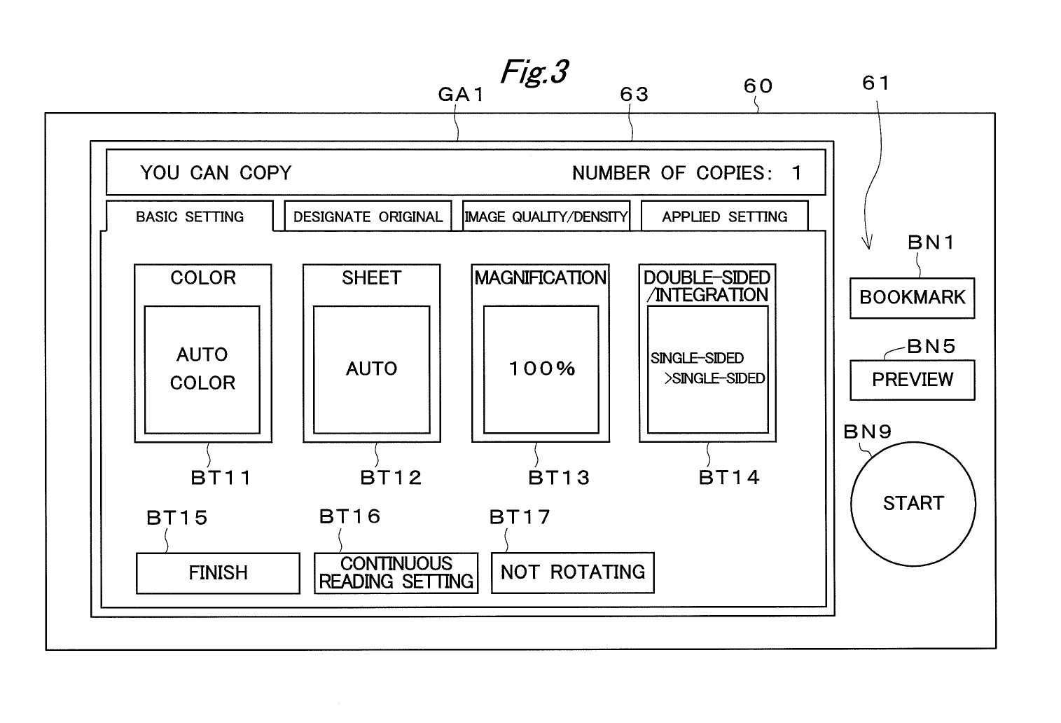

Specifically, in the image forming apparatus 1, an operation panel unit 60 (see FIG. 3) that functions as the input/output unit 6 is provided. This operation panel unit 60 includes: a hard key 61 (BN1, BN5, BN9 and the like), and a touch screen 63.

The hard key 61 functions as a part of the operation input unit 6a. The hard key 61 includes a bookmark registration button BN1, a preview button BN5, a start button BN9, and the like.

Moreover, the touch screen 63 is configured in such a manner that a piezoelectric sensor and the like are embedded in a liquid crystal display panel. The touch screen 63 functions as a part of the display unit 6b, and in addition, also functions as a part of the operation input unit 6a. In detail, the touch screen 63 is capable of displaying various pieces of information on the liquid crystal display panel, and in addition, is also capable of accepting a variety of inputs by sensing operation positions of an operator's finger for the liquid crystal display panel. For example, when a virtual button displayed on the touch screen 63 is touched by the operator's finger, such an operation is regarded as a pressing operation for the virtual button.

Thus, the input/output unit 6 is capable of accepting the input operations (for example, a variety of setting operations using a menu screen, and the like) executed by the operator.

The controller 9 is a control unit that comprehensively controls the image forming apparatus 1, and includes a CPU and a variety of semiconductor memories (a RAM, a ROM and the like). The variety of processing units operate under control of the controller 9, whereby the variety of functions of the image forming apparatus 1 are realized. The controller 9 executes, in the CPU, a predetermined software program (hereinafter, also simply referred to as a program) PG stored in the ROM (such as an EEPROM), and thereby realizes the variety of processing units. Note that the program PG and the like may be installed by being downloaded through the network. Alternatively, the program PG and the like may be recorded in a variety of computer-readable portable recording media (a USB memory and the like), and may be installed by being read out from the recording media.

Specifically, the controller 9 realizes a variety of processing units including a mode setting unit 11, a bookmark registration unit 12, a bookmark call-up unit 13, a screen creation unit 14, and a display control unit 15.

The mode setting unit 11 is a processing unit that sets a variety of processing modes regarding the target image of printing processing. For example, the mode setting unit 11 sets modes regarding a variety of print output states such as a “single-sided” printing mode, a “double-sided” printing mode, and a “2-in-1” mode.

The bookmark registration unit 12 is a processing unit that registers setting items (also referred to as “bookmark items” (to be described later)) for re-sets regarding the printing processing.

The bookmark call-up unit 13 is a processing unit that calls up the “bookmark items” (setting items for the re-sets) registered by the bookmark registration unit 12.

The screen creation unit 14 is a processing unit that creates a variety of screens (GA, GB and the like) to be displayed on the touch screen 63 and described later. This screen creation unit 14 creates such a preview-added screen GB (described later) having a preview image PV and a menu image MN.

The display control unit 15 is a processing unit that controls a display operation of displaying, on the touch screen 63, the variety of screens created by the image creation unit 14, and the like.

<1-2. Operations>

<Basic Operation>

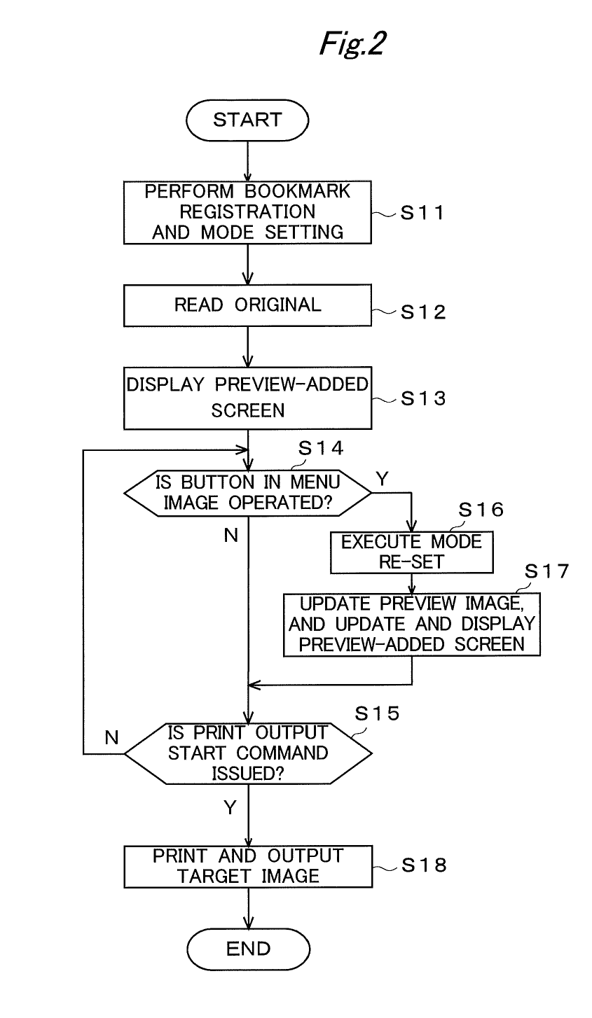

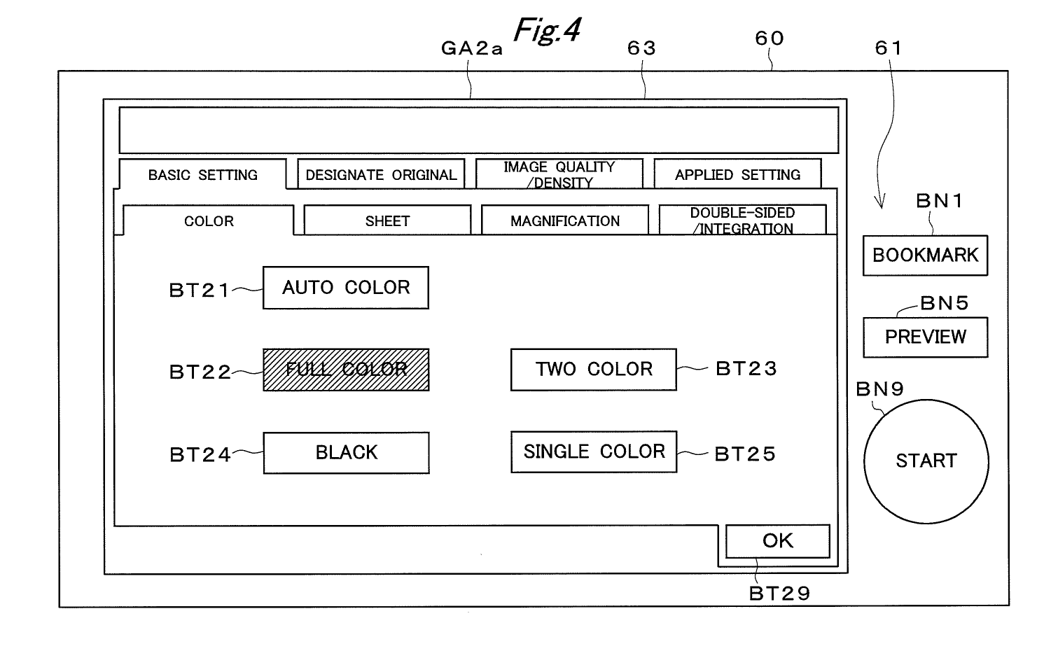

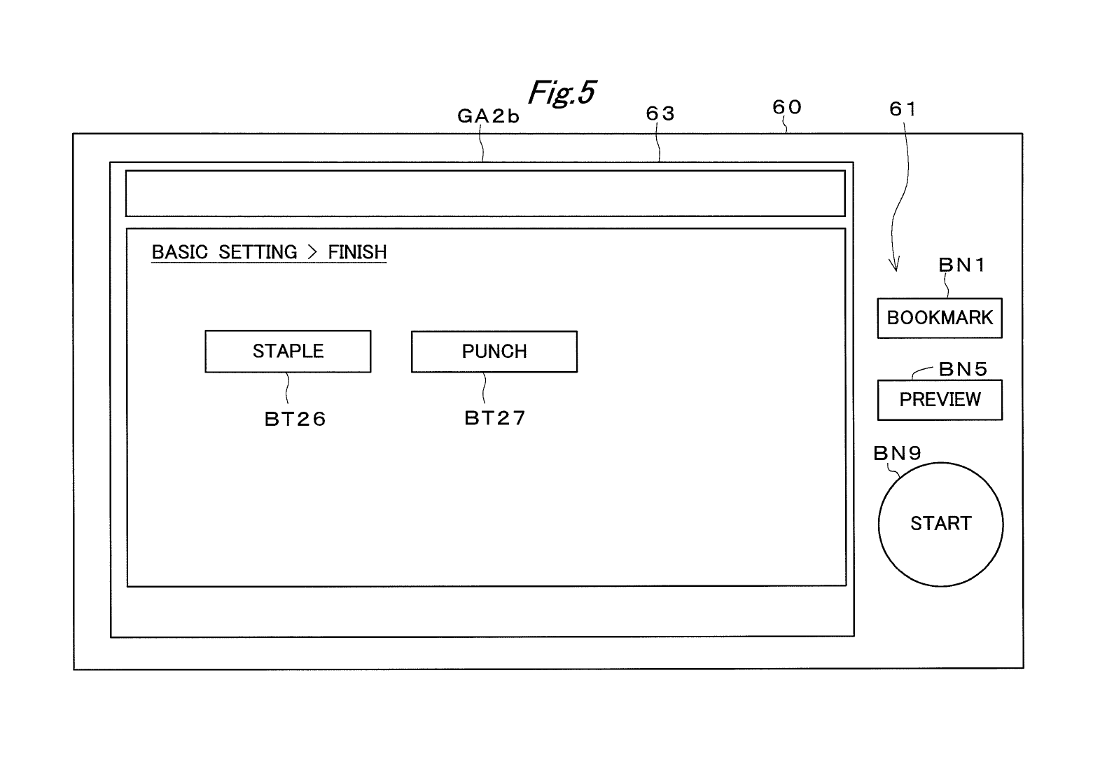

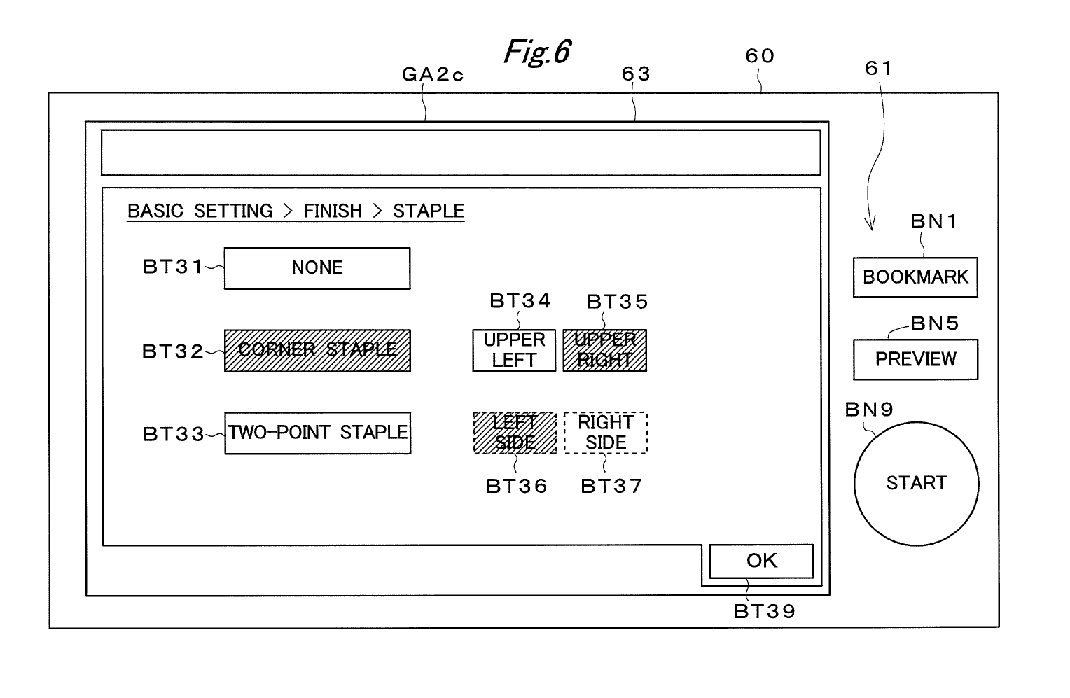

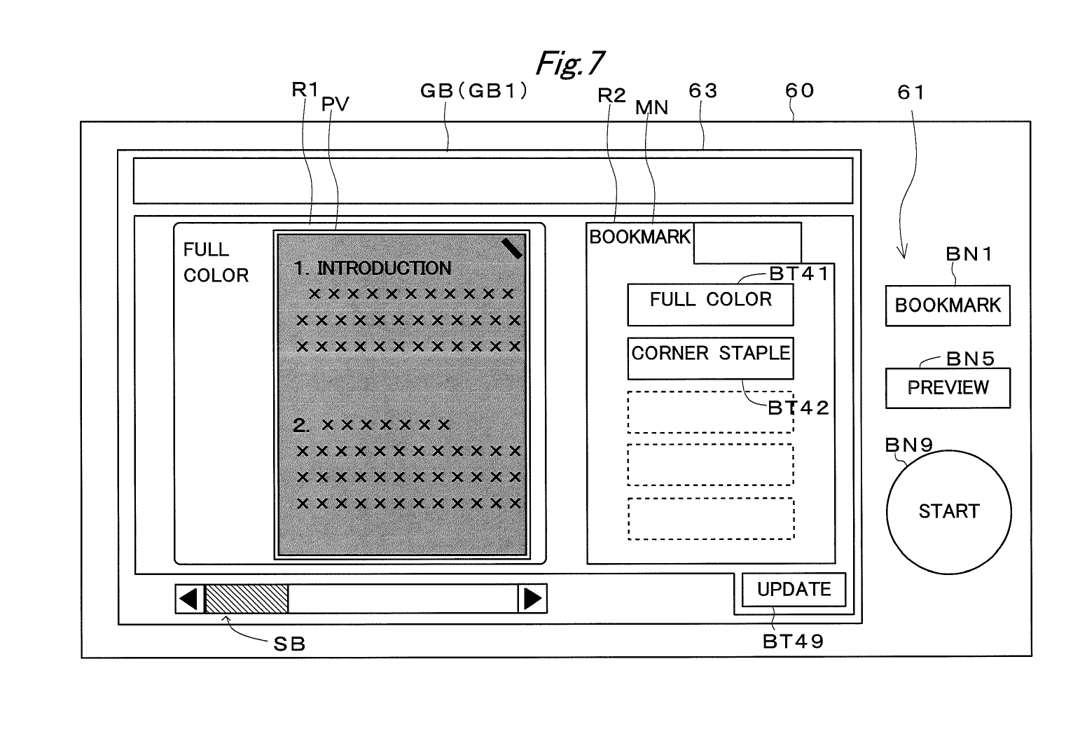

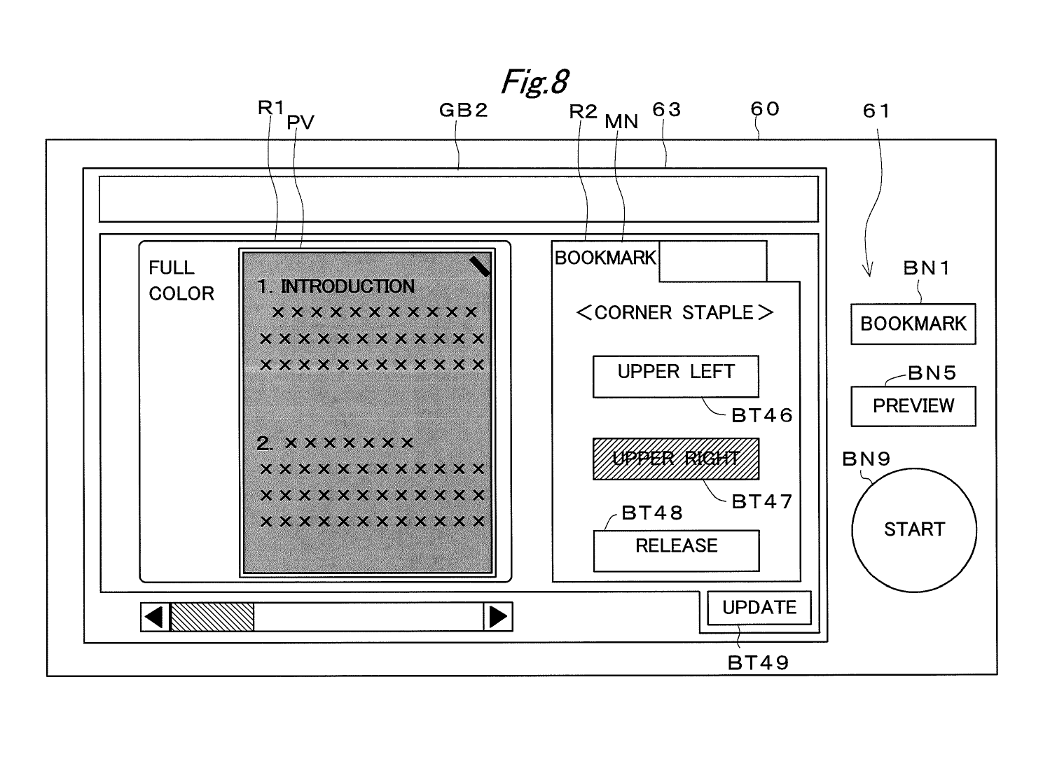

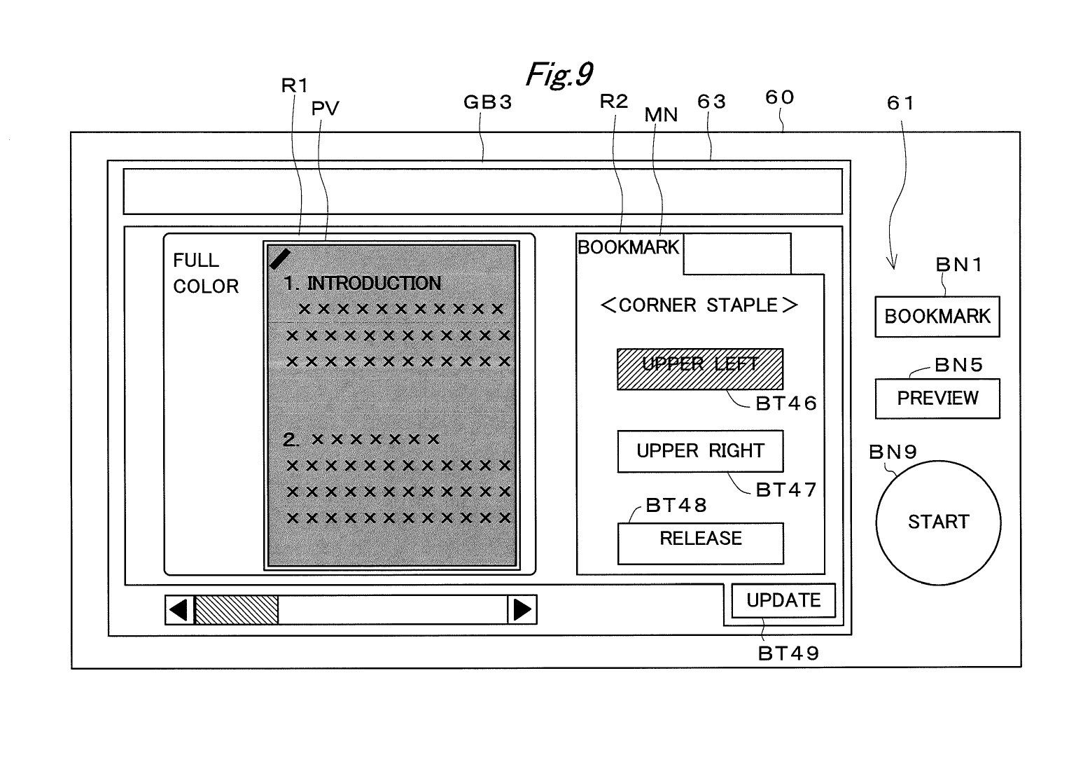

Next, a description is given of a copy job, which is accompanied with setting processing (mode setting processing) and a preview, while referring to FIG. 2 to FIG. 9. In this copy job, there are further executed re-set processing for re-setting a part or whole of a mode setting set by initial mode setting processing, and a re-preview that reflects setting change contents in the re-set processing. FIG. 2 is a flowchart showing the copy job. Moreover, FIG. 3 is a view showing a setting screen (basic setting screen) GA1 regarding “basic setting” of the operation panel unit 60, FIG. 4 is a setting screen GA2 (GA2a) for performing setting operations regarding “color”, and FIG. 5 and FIG. 6 are setting screens GA2 (GA2b, GA2c) for performing setting operations regarding “finish”. Moreover, FIG. 7 is a view showing a screen GB (GB1) including a preview image (preview image before a re-set operation) PV on which an initial setting is reflected, FIG. 8 is a view showing a screen GB (GB2) during the re-set operation, and FIG. 9 is a view showing a screen GB (GB3) including the preview image PV after the re-set operation.

In this embodiment, it is assumed that the setting items (also referred to as “bookmark items”) for the re-sets regarding the printing processing are registered for each of jobs. In other words, it is assumed that operations of registering the individual bookmark items are executed for copy jobs different from one another.

The flowchart of FIG. 2 is referred to. As shown in FIG. 2, first, bookmark registration and mode setting are performed in an activation state of the image forming apparatus 1 (step S11).

Specifically, an operation user (also simply referred to as a user) UA of the image forming apparatus 1 performs a user authentication operation by using the operation panel unit 60 (FIG. 3) and the like, and thereafter, presses down the bookmark registration button BN1 in the operation panel unit 60. The image forming apparatus 1 regards the pressing operation for the bookmark registration button BN1 as a start command of “bookmark registration processing”, and starts to accept a registration operation of the bookmark. Note that, in this embodiment, it is assumed that the registration operations of the bookmarks are mode setting operations. In other words, in this embodiment, it is assumed that the setting items, of which modes are set by the mode setting operations executed by the user UA, are registered as the setting items (bookmark items) for the re-sets.

Specifically, with regard to this copy job, the user UA executes the mode setting operation by using the screens GA1 and GA2. In detail, the user UA selects target items of the mode setting by using the screen GA2 and the like. Such a selection operation regarding this mode setting also serves as a registration operation (bookmark registration operation) of bookmark items regarding such a processing target job, and setting items set by the mode selection operation (mode setting operation before the preview) as described above are registered as target items of “bookmark registration”.

A description is given below in detail of the case where the mode setting regarding two types of the setting items (“full color” and “corner staple”) is performed, and both of the setting times (“full color” and “corner staple”) are registered as “bookmark items” (see FIG. 7).

First, a description is given of the mode setting operation regarding “full color”.

In FIG. 3, the setting screen GA1 regarding “basic setting” is displayed on the touch screen 63. On the setting screen GA1, (virtual) buttons BT11 to BT17 are displayed, which correspond to a variety of setting items such as “color”, “sheet”, “magnification”, and “double-sided/integration”. Note that, by switching a tab, it is also possible to display a setting screen (for example, setting screen regarding “applied setting”) other than the setting screen regarding “basic setting” on the touch screen 63.

When any of the buttons BT11 to BT17 of FIG. 3 is pressed down, a detail setting screen of a setting item corresponding thereto is displayed on the touch screen 63. The user UA can execute a variety of detail settings by using the detail setting screen. Here, it is assumed that the “color” button BT11 is pressed down, and that the detail setting screen GA2a of FIG. 4 is displayed on the touch screen 63.

When a “full color” button BT22 is pressed down on the screen GA2a, and an OK button BT29 is further pressed down thereon, the image forming apparatus 1 sets a “full color” mode regarding the copy job (mode setting). Moreover, the image forming apparatus 1 also registers “full color” as the bookmark item (re-set item). Thereafter, the image forming apparatus 1 displays the screen GA1 (FIG. 3) on the touch screen 63 one more time.

Next, a description is given of the setting operation and the like regarding “corner staple”.

When the button BT15 on a lower portion in the screen GA1 is pressed down, the detail setting screen GA2b of FIG. 5 is displayed on the touch screen 63. When a “staple” button BT26 is pressed down on the screen GA2b, then the detail setting screen GA2c of FIG. 6 is displayed on the touch screen 63. On the screen GA2c, a “corner staple” button BT32 is pressed down, and position designation of the corner staple is performed. Here, it is assumed that an “upper right” button BT35 indicating that the corner staple should be arranged at “upper right” is pressed down.

Thereafter, when the OK button BT39 is pressed down, the image forming apparatus 1 sets “corner staple” regarding the copy job. In detail, the image forming apparatus 1 sets that “corner staple” should be implemented at an “upper right” position of each sheet. Moreover, the image forming apparatus 1 also registers “corner staple” as the bookmark item (re-set item). By this registration, a re-set operation regarding the corner staple, which will be described later, becomes possible. Note that the image forming apparatus 1 displays the screen GA1 (FIG. 3) on the touch screen 63 one more time.

Upon ending the setting operations regarding the two items (“full color” and “corner staple”) in such a manner as described above, the user UA presses down the preview button BN5 in a state where the original is mounted on an auto document feeder (ADF).

In response to the pressing operation for the preview button BN5, the image forming apparatus 1 optically reads the original, and creates an image for copy (step S12).

Moreover, based on the image for the copy, the image forming apparatus 1 also creates the preview image PV on which setting contents as described above are reflected. This preview image PV is an image indicating the print output state regarding the target image of the printing processing. Furthermore, the image forming apparatus 1 also creates the menu image MN including “bookmark items”. This menu image MN is also expressed as an image that displays a menu for the re-set regarding the printing processing.

Then, the preview-added screen GB (GB1 (FIG. 7)) is displayed on the touch screen 63 (step S13). This preview-added screen GB (GB1) has a preview display region R1 and a bookmark display region R2. The preview-added screen GB is a menu screen, and accordingly, is also referred to as a preview-added menu screen GB.

The preview image PV is displayed on the preview display region R1, and the menu image MN is displayed on the bookmark display region R2. Here, the preview image PV and the menu image MN are arrayed side by side so as to be comparable with each other, and are displayed simultaneously in parallel to each other. Note that, on the preview image PV of FIG. 7, it is shown that the “full color” setting and the “(upper right) corner staple” setting are made. Moreover, a scroll bar SB provided in conjunction with the preview display region R1 is operated, thus making it possible to change a display target page in the preview display region R1. In such a way, it is possible to individually browse a plurality of pages of a printing target document.

The user UA visually recognizes the preview image PV displayed on the preview display region R1, and determines whether or not the setting contents are correct. In the case where the setting contents are correct, the user UA directly presses down the start button BN9. Meanwhile, in the case where the setting contents should be corrected, the user UA performs the re-set operation by using the menu image MN displayed on the bookmark display region R2. Specifically, at least either one of setting item buttons BT41 and BT42 (see FIG. 7) registered as the bookmarks is pressed down, whereby the re-set operation is executed. Here, it is assumed that two setting items (“full color” and “corner staple”) are registered by the above-mentioned bookmark registration operation, and that “bookmark items” corresponding to the two setting items are displayed in the menu image MN.

A description is mainly given below of the case where the setting change regarding “corner staple” is performed based on a result of the visual recognition of the preview image PV.

Upon displaying the screen GB1 on the touch screen 63 (step S13), the image forming apparatus 1 stands by for a bookmark operation (pressing operation for the button in the menu image MN) and a print output command (pressing operation for the start button BN9) (steps S14 and S15). Note that an operation of standing by for “bookmark operation” is also expressed to be an operation of accepting the setting change input regarding “bookmark item” in the menu image MN.

Then, in the case of detecting the pressing operation for the start button BN9, the image forming apparatus 1 proceeds from step S15 to step S18, and prints and outputs such a processing target image based on the setting contents. In the case of not detecting the pressing operation for the start button BN9, the image forming apparatus 1 repeatedly executes detection processing performed in steps S14 and S15.

Meanwhile, in the case of detecting the pressing operation for the button in the menu image MN during a standby period for the pressing operation for the start button BN9 (YES in step S14), the image forming apparatus 1 executes a re-set operation (step S16) regarding the bookmark item and a display operation (step S17) of the preview image PV updated by the re-set operation.

More specifically, upon detecting the pressing operation for the button in the menu image MN, the image forming apparatus 1 displays, on the bookmark display region R2, a detail setting image (new menu image MN) of a setting item corresponding to the pressing target button in response to the pressing operation. For example, when the “corner staple” button BT42 (FIG. 7) is pressed down, a menu image MN (see FIG. 8) for a detail setting regarding “corner staple” is displayed on the bookmark display region R2. In detail, a menu image MN having menu item buttons regarding a lower hierarchy of “corner staple”, more in detail, having buttons (“upper left” button BT46 and “upper right” button BT47) for setting a position of the corner staple is displayed on the bookmark display region R2. Moreover, a setting button BT48 that releases such a mode setting of “corner staple” is also included in the menu image MN.

Moreover, by using this detail setting image, the user UA can perform a setting change operation, for example, a setting change (mode re-set) of the position of “corner staple” from “upper right” to “upper left”. In detail, the user UA presses down the “upper left” button BT46, thereby sets “upper left” at a selected state (and sets “upper right” at a non-selected state), and thereafter, presses down an “update” button BT49. In such a way, the re-set operation (step S16) regarding the bookmark item is performed. Note that such a pressing operation for the “update” button BT49 is assumed to be an operation of giving both of an update command (update determination command) of the mode re-set contents and an update command of the preview image PV.

Furthermore, in response to the pressing operation for the “update” button BT49, the image forming apparatus 1 re-creates (updates) the preview image PV based on the setting contents (re-set setting contents regarding the re-set item) which have undergone the setting change operation, and displays the re-created (updated) preview image PV on the preview display region R1 (step S17). As a result, such an updated screen GB3 as shown in FIG. 9 is displayed on the touch screen 63. In the updated preview image PV, the position of the corner staple is changed from “upper right” to “upper left”. The user UA visually recognizes the preview image PV in the screen GB3, and thereby can confirm that the position of the corner staple is set at a correct position. Then, the processing proceeds to step S15.

Thereafter, when the start button BN9 is pressed down at appropriate timing, print output processing is executed by using the image for the copy, which is acquired in step S12. Specifically, the target image of the printing processing is printed and outputted based on the re-set setting contents (setting contents which have undergone the setting change) (step S18).

As described above, on the preview-added screen GB1 (FIG. 7), the preview image PV, on which the initial setting contents are reflected, and the menu image MN for the re-set are displayed simultaneously in parallel to each other. In detail, the preview image PV is displayed on the preview display region R1 in the screen GB1, and the menu image MN is displayed on the bookmark display region (re-set item display region) R2 in the screen GB1. Then, the user UA can confirm whether or not the setting contents are correct by using this screen GB1. More in detail, the user UA views the preview image PV, which is not updated yet, in the screen GB1 (FIG. 7), and gets to know that the position of “corner staple” is not a desired position.

Then, in a state where both of the preview image PV and the menu image MN are displayed, the re-set operation using the menu image MN is performed. More in detail, while visually confirming the preview image PV, the user UA presses down the “corner staple” button BT42 on the menu image MN of the screen GB1, further, presses down the “upper left” button BT46 on the menu image MN on the screen GB2 (FIG. 8), and thereby can perform the setting change operation.

Thus, while viewing the preview image PV that is not updated yet, the user UA can recognize that the correct position of the “corner staple” is not “upper right” but “upper left”, and can perform such a change operation as mentioned above. In other words, the user UA is capable of performing the re-set operation while visually recognizing both of the preview image PV and the menu image MN in parallel to each other. Hence, in comparison with the case where the preview image PV becomes temporarily invisible, the change operation can be performed with peace in mind while viewing and confirming the preview image PV, and it is possible to reduce an erroneous recognition and the like. Accordingly, high operability can be obtained.

Moreover, immediately after the re-set operation using the menu images MN (FIG. 7 and FIG. 8), the preview image PV (FIG. 9), on which the re-set contents by the menu images MN are reflected, is updated and displayed on the preview display region R1. Therefore, immediately after the re-set operation, the user can immediately confirm the updated preview image PV on the preview display region R1.

In detail, in response to the pressing of the update button BT49, the setting change result is immediately reflected on the preview image PV of the screen GB3. In other words, the preview image PV is changed while the preview display region R1 is being left displayed. More in detail, while performing the setting change by using the menu image MN of the bookmark display region R2 on the right side, the preview image PV on which the setting change is reflected is displayed on the preview display region R1 on the left side.

According to this, in response to the pressing of the update button BT49, the preview image PV in the preview display region R1 is changed from the one before the setting change to the one after the setting change while the display states of both of the preview display region R1 and the bookmark display region R2 are being maintained. Therefore, such a reflection result of the setting change operation can be confirmed while suppressing movement of eyes to the minimum. In other words, in an easy-to-understand mode, it is possible to visually recognize that the position of “corner staple” is changed from “upper right” to “upper left”. That is, it is easy to confirm the change of the preview image PV.

Moreover, in the above, the setting items having high possibility to be changed in setting are registered as “bookmark items” in response to the operations by the user (bookmark registration). Therefore, it is possible to effectively utilize “bookmark display region R2” of which size (area) is limited. In detail, if an extremely large number of setting items are arranged as the bookmark items in “bookmark display region R2”, then such a problem may occur that it becomes difficult for the user to look for a desired change target item. As opposed to this, according to the above-described mode, the setting items selected carefully in number by the user (that is, the setting items having high possibility to be changed in setting) are registered as “bookmark items” on the bookmark display region R2. In short, “narrowing” regarding the bookmark items is performed. Hence, the occurrence of such a problem can be avoided, and high operability can be ensured. Then, both of the bookmark display region R2 and the preview display region R1 as described above are displayed on the preview-added screen GB, whereby it is also possible to avoid reduction of a size of the preview display region R1 and to continue to largely display the preview image PV. That is, it is possible to present an easy-to-view preview image while ensuring the high operability.

<Re-Set Operations Using Other Bookmark Items>

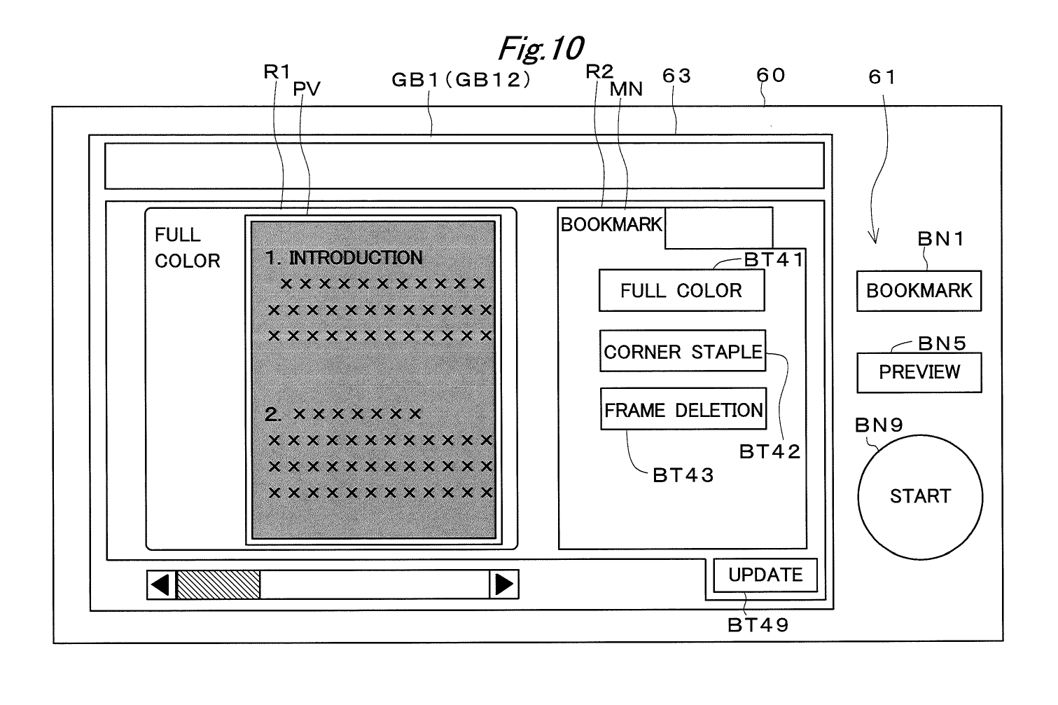

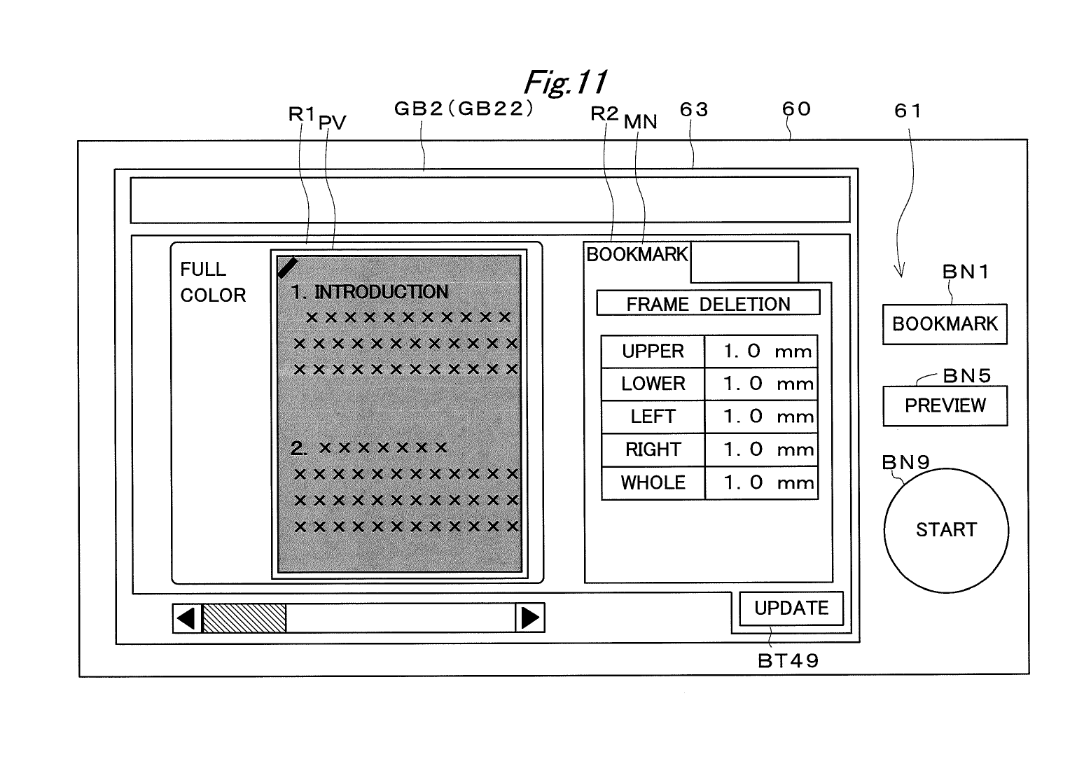

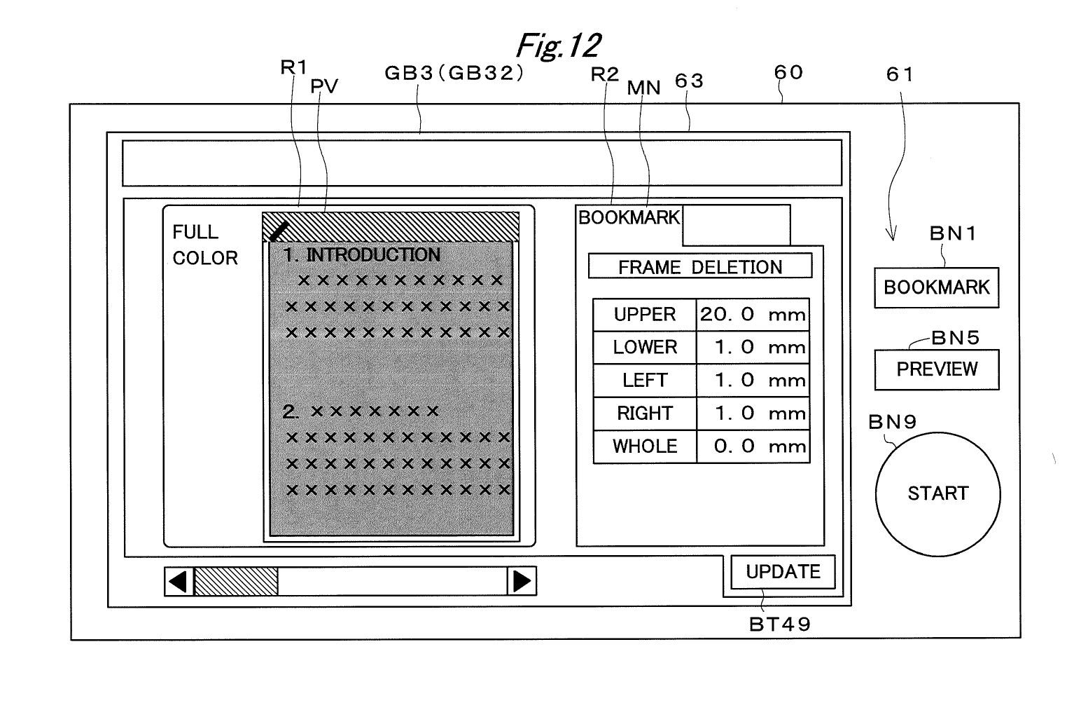

The description has been mainly given above of the setting change operation regarding the position of “corner staple”; however, in the image forming apparatus 1, it is possible to perform other various setting changes in a similar way. Referring to FIG. 10 to FIG. 12 and the like, the case is further illustrated below, where a setting change regarding “frame deletion” is performed by using the menu screens GB (GB1 to GB3), each having the preview image PV and the menu image MN. FIG. 10 is a view showing a preview-added screen GB1 (GB12) in which “frame deletion” is registered as “bookmark item”. Moreover, FIG. 11 is a view showing a screen GB2 (GB22) including a detailed menu image MN and the like for re-set regarding “frame deletion”, and FIG. 12 is a view showing a screen GB3 (GB32) including a preview image PV and the like, on which a setting change result is reflected.

Here, it is assumed that, in step S11 of the flowchart shown in FIG. 2, both of the mode setting operation and the bookmark registration operation are performed also regarding “frame deletion” in addition to “full color” and “corner staple”, which are mentioned above. Then, the preview button BN5 is pressed down, whereby an original reading operation (step S12) is performed, and the preview-added screen GB1 (GB12) as shown in FIG. 10 is displayed on the touch screen 63 (step S13). In a bookmark display region R2 of the screen GB12, a “frame deletion” button BT43 is also displayed in addition to the above-mentioned buttons BT41 and BT42. Note that, in FIG. 10, from the beginning, the case is assumed, where “upper left” is designated as the position of “corner staple”.

When the “frame deletion” button BT43 in the bookmark display region R2 of this screen GB1 (GB12) is pressed down, the screen GB2 (GB22) as shown in FIG. 11 is displayed on the touch screen 63. The screen GB 22 has a substantially similar configuration to that of the screen GB12. However, the screen GB22 is different from the screen GB12 in that the menu image MN of the bookmark display region R2 is changed to an image for detail setting regarding “frame deletion”. Specifically, on the screen GB22, setting columns regarding the respective frame deletion region widths of upper, lower, left and right sides are provided in place of the buttons BT41 to BT43. Specifically, the respective setting columns are provided, which are for individually setting the “upper” width (upper frame deletion region width), the “lower” width (lower frame deletion region width), the “left” width (left frame deletion region width), the “right” width (right frame deletion region width), and the like. Note that, in FIG. 11, the case is assumed, where “1.0 mm” is designated as an initial setting in each of “upper”, “lower”, “left” and “right”.

The image forming apparatus 1 receives at least one change input regarding a plurality of detail setting items by using this screen GB2 (GB22). Then, in response to the change inputs, the image forming apparatus 1 updates and displays the preview image PV in which corresponding portions are updated.

Specifically, by using cursor keys, numeric keys (not shown) and the like in the operation panel unit 60, the user UA inputs a numeric value after the change to “setting column regarding frame deletion region width”, and presses down the update button BT49. In response to such a pressing operation, the image forming apparatus 1 creates a (updated) preview image PV corresponding to the changed numeric value. Then, the image forming apparatus 1 updates the preview image PV in the preview display region R1, and displays the screen GB3 (GB32) on the touch screen 63. The screen GB32 (FIG. 12) has a substantially similar configuration to that of the screen GB22. However, the screen GB32 is different from the screen GB22 in that the preview image PV is changed (updated) to the image on which the detail setting contents regarding “frame deletion” are already reflected, and so on. Specifically, in response to that the “upper” width has undergone the setting change from 1 mm to 20 mm by using the setting column of the bookmark display region R2, the changed frame deletion region (laterally long band-like region) on an upper end is shown in a blinking manner on the preview image PV of the preview display region R1 of FIG. 12. In such a way, the user UA can easily get to know such a changed portion.

Moreover, similar setting operations can also be performed for setting columns for setting the widths other than the “upper” width (that is, setting columns for setting the respective “lower”, “left” and “right” widths).

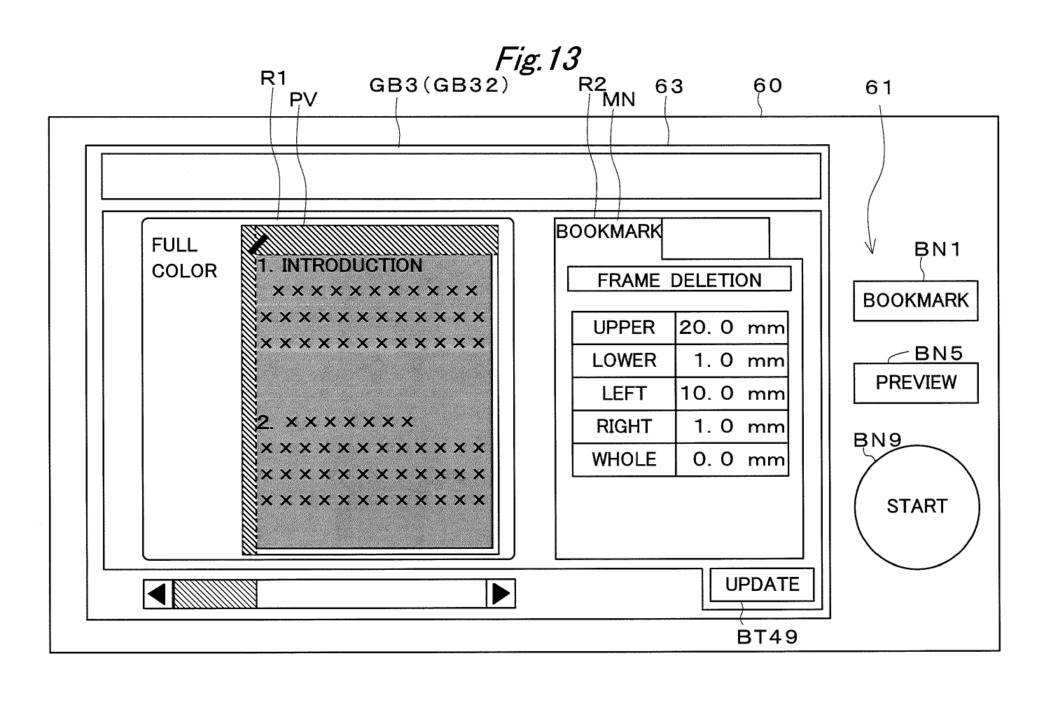

For example, when the user UA further inputs a numeric value (10 mm) after the change to a “left” setting column in the bookmark display region R2 of FIG. 12, and presses down the update button BT49, the image forming apparatus 1 creates a (updated) preview image PV corresponding to the changed numeric value. Then, the image forming apparatus 1 updates and displays the preview image PV in the preview display region R1. In FIG. 13, the updated screen GB 32 is shown. In response to that the “left” column has undergone the setting change from 1 mm to 10 mm by using the setting column of the bookmark display region R2, the changed frame deletion region (longitudinally long band-like region) on a left end is shown in a blinking manner on the preview image PV of the preview display region R1 of FIG. 13. In such a way, the user UA can easily get to know such a changed portion. Moreover, individually for the plurality of detail setting items (“upper” and “left”), the user UA can easily get to know what contents are changed.

As described above, on the preview image PV, in response to the setting changes regarding the plurality of detail setting items, the plurality of portions corresponding thereto are updated. Hence, it is easy to grasp changed spots corresponding individually to the plurality of detail setting items.

In particular, in the case where the change operations are performed step by step for the plurality of detail setting items as described above, the change contents in the respective stages can be easily grasped. Accordingly, such step-by-step change operations are extremely useful.

Moreover, in a period while the plurality of detail setting items are being changed step by step, the preview image PV continues to be displayed on the touch screen 63 on the preview display region R1. Accordingly, in comparison with the case where the preview display region R1 and the preview image PV temporarily come not to be displayed, it is easy to specify changed portions.

Moreover, while accepting the setting change operations regarding the plurality of detail setting items on the bookmark display region R2 on the right side in the touch screen 63, the image forming apparatus 1 displays the preview image PV, on which the change contents regarding the plurality of detail setting items are reflected, on the preview display region R1 on the left side in the touch screen 63. Hence, reflection results of the setting change operations regarding the plurality of detail setting items can be confirmed while suppressing the movement of the eyes to the minimum.

Note that, in the above-described embodiment, the case has been illustrated, where, after the bookmark registration button BN1 is pressed once, the buttons (BT22, BT32 and the like) regarding the plurality of setting items are pressed down to perform the plurality of mode setting operations, and the plurality of setting items are collectively registered also as the bookmark items. However, the present invention is not limited to this. For example, every time of performing the mode setting regarding the respective setting items by pressing down the respective setting item buttons, the bookmark registration button BN1 may be pressed down immediately thereafter, and the item regarding the mode setting immediately before the bookmark registration button is pressed down may be registered as “bookmark item”.

Moreover, in the above-described embodiment, the description has been given of the case where the setting items for which the mode setting is performed in the mode setting operations regarding the processing target job are also registered as the bookmark items (That is, the case where the mode setting operations also serve as bookmark registration operations). However, the present invention is not limited to this. For example, the mode setting operations and the bookmark registration operations may be performed as separate and independent operations. More specifically, first, the usual mode setting operations (mode setting operations of “full color” and “corner staple”) are performed, and next, after the bookmark registration button BN1 is pressed down, “bookmark registration operation” (bookmark registration operations of “full color” and “corner staple”) may be executed (independently of the mode setting operations). In this case, the setting items corresponding to the buttons pressed down after the bookmark registration button BN1 is pressed down are not reflected on the actual mode setting. However, as mentioned above, in accordance with the operations of registering the setting items, for which the mode setting is performed in the setting operations regarding the processing target job, also as the registration items, duplicate operations can be avoided.

### 2. Second Embodiment

In the above-described first embodiment, the case has been illustrated where only the setting items, for which the mode setting is performed by the setting operations by the user, are registered as “bookmark item” (see step S11 in FIG. 2).

In this second embodiment, a description is given of the case where setting items other than the setting items which have undergone the mode setting can also be registered as “bookmark item”. In detail, a description is given of the case where, in response to the setting operations by the user, a plurality of the setting items are registered as “bookmark item”, and setting items as a part thereamong actually undergo the mode setting. More specifically, the case is illustrated, where, in response to the setting operations of the user, three setting items, which are “full color”, “corner staple” and “two-point staple”, are registered as “bookmark item”, and mode setting regarding two setting items thereamong, which are “full color” and “corner staple”, is performed. In accordance with this, a setting item having a possibility to be changed in the job (here, “two-point staple”) can be registered as “bookmark item” in advance.

First, in a similar way to the first embodiment, the setting operations for “full color” and “corner staple” are performed after the bookmark registration button BN1 is pressed down, and “full color” and “corner staple” are registered as the bookmarks. For “corner staple”, the setting operation is performed by using the screen GA2c (FIG. 6). Thereafter, after the screen GA2c is called up again, a “two-point staple” button BT33 and the OK button BT39 are pressed down, and “two-point staple” is also selected and registered as an item (“bookmark item”) for the re-set (for the setting change).

However, the two setting items, which are “two-point staple” and “corner staple”, cannot undergo the mode setting at the same time. In other words, “two-point staple” and “corner staple” have a competitive relationship, and are capable of undergoing the mode setting only exclusively. In this connection, in the case where setting operations regarding the plurality of setting items competing with one another are performed, it is assumed that all of the plurality of setting items are registered as “bookmark item”, and meanwhile, the target items of the mode setting are decided based on an order of the setting operations (here, while giving priority to “preceding setting”). In detail, the setting item set first between two setting items selected as “bookmark item” and competing with each other is decided as the target item of the mode setting. Specifically, the setting item “corner staple” corresponding to the “corner staple” button BT32 pressed down first after the bookmark registration button BN1 is pressed down undergoes the mode setting. Meanwhile, “two-point staple” set thereafter is not reflected on the mode setting.

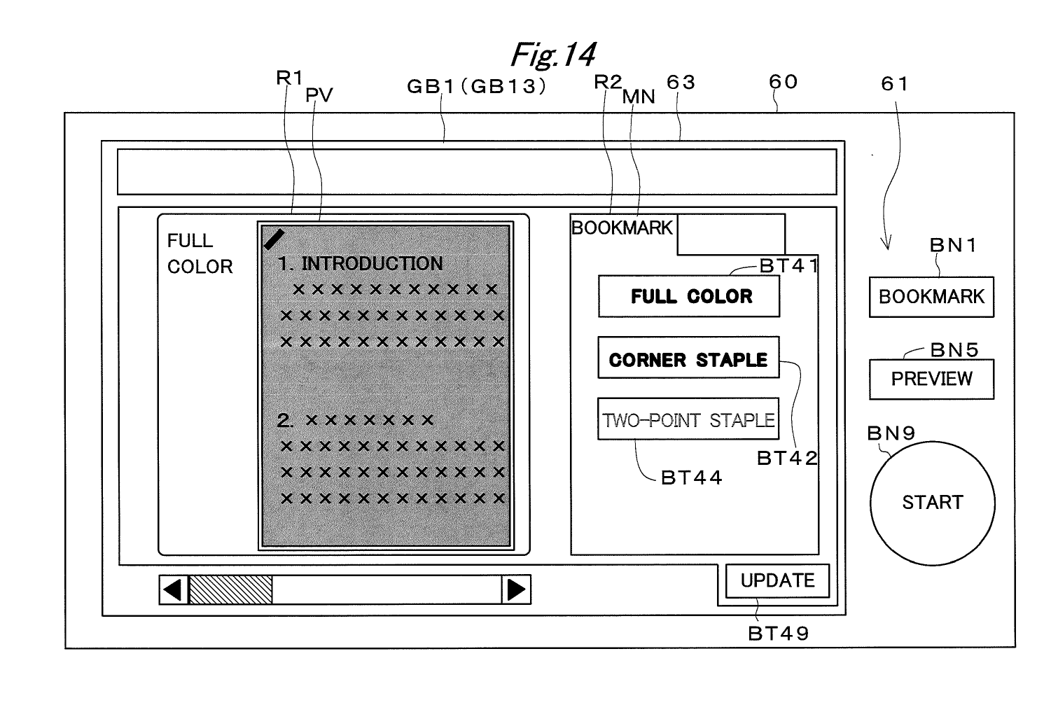

As a result, as shown in FIG. 14, on the preview image PV on the left side in the screen GB1 (GB13), it is shown that the processing target image is scheduled to be printed and outputted in “full color”, and that “corner staple” will be implemented. Note that an image schematically showing “two-point staple” is not displayed in the screen GB13, and it is also shown that “two-point staple” has not undergone the mode setting.

Moreover, on the menu image MN on the right side in the same screen GB1 (GB13), buttons BT41, BT42 and BT44 regarding three bookmark items for the re-set are displayed. That is, it is shown that three setting items which are “full color”, “corner staple” and “two-point staple” have undergone “bookmark registration”.

In FIG. 14, the items (“full color” and “corner staple”) which have undergone the mode setting and the item (“two-point staple”) which has not undergone the mode setting are displayed in different modes (that is, while being distinguished from each other). Specifically, the former ones are displayed in blue characters highlighted in bold, and the latter one is displayed in dimmed characters with a usual thickness. Thus, in accordance with whether or not the respective bookmark items have undergone the mode setting, the respective bookmark items are displayed so as to be distinguished in the modes different from each other. Therefore, the user can easily determine whether or not the respective bookmark items which have undergone the mode setting. Note that, here, the case has been illustrated, where whether or not each “bookmark item” in the bookmark display region R2 is the item which has undergone the mode setting is distinguished by both of “thickness of characters” and “color of characters”. However, the present invention is not limited to this, and only either one of “thickness of characters” and “color of characters” may be used for the distinction.

Then, the user can perform the mode setting for “two-point staple” by pressing down the button BT44 in the menu image MN as described above. That is, the re-setting operation can be performed.

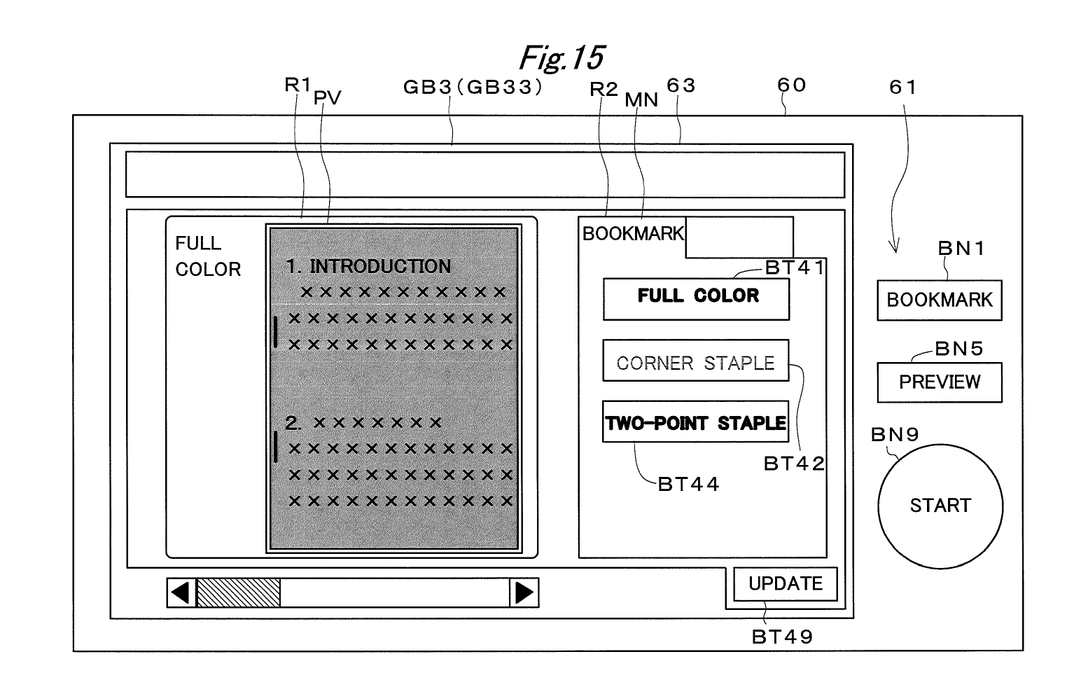

Specifically, when the user further presses down the update button BT49 after pressing down the “two-point staple” button BT44, the image forming apparatus 1 performs the mode setting for “two-point staple”, and executes a setting change operation of releasing the mode setting for “corner staple”. Moreover, the image forming apparatus 1 creates a (updated) preview image PV corresponding to setting contents after the change. Furthermore, the image forming apparatus 1 updates the preview image PV in the preview display region R1, and displays a screen GB3 (GB33) as shown in FIG. 15 on the touch screen 63. The screen GB33 (FIG. 15) has a substantially similar configuration to that of the screen GB13 (FIG. 14). However, in response to that the setting change is performed from “corner staple” to “two-point staple”, not the preview image PV schematically showing “corner staple” but the preview image PV (image on the left side, including two short segments showing two binding portions) schematically showing “two-point staple” is displayed in the preview display region R1. Moreover, in the menu screen MN, not the “corner staple button BT42 but the “two-point staple” button BT44 is highlighted. In such a way, the user UA can get to know the contents after the setting change.

Here, in the preview image PV of FIG. 15, it is preferable that such a changed portion (for example, the two segments showing the two-point staple) be shown in a blinking manner. In accordance with this, the user UA can get to know the changed portion more easily. Moreover, here, it is assumed that “two-point staple” is automatically decided at positions for left binding, however, the setting change can also be performed for “binding position” by using the detail setting screen of “two-point staple”. In accordance with this, a more detailed setting change operation and the like can also be executed.

Note that, here, the case has been illustrated, where whether or not each “bookmark item” in the bookmark display region R2 is the item which has undergone the mode setting is distinguished by “thickness of characters”, “color of characters” and the like, however, the present invention is not limited to this.

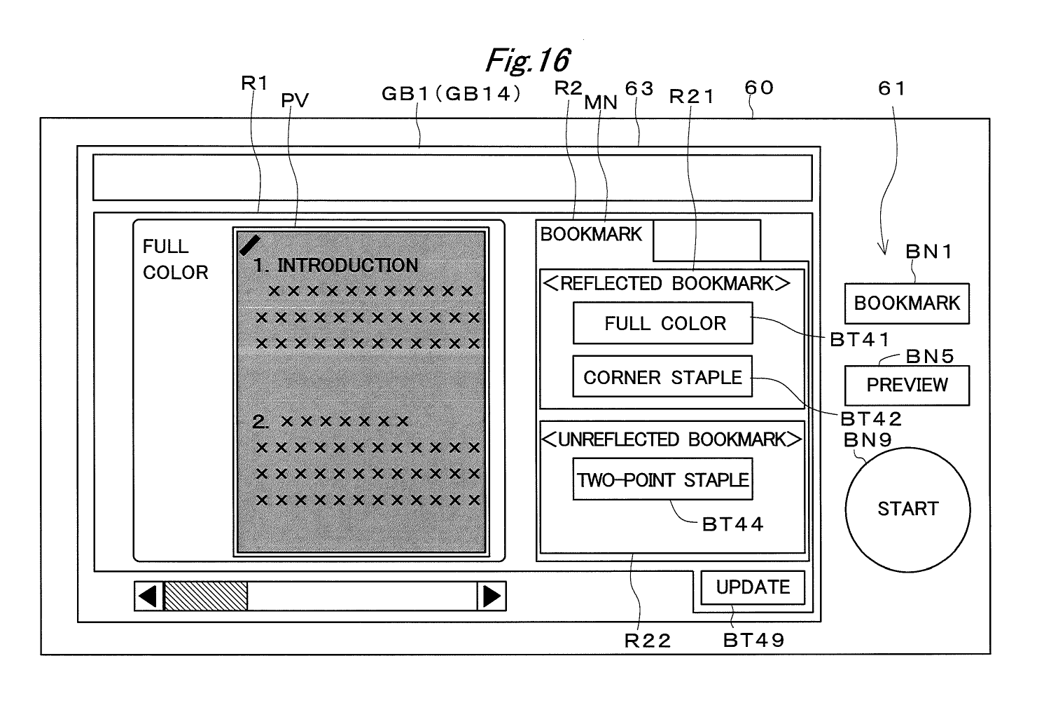

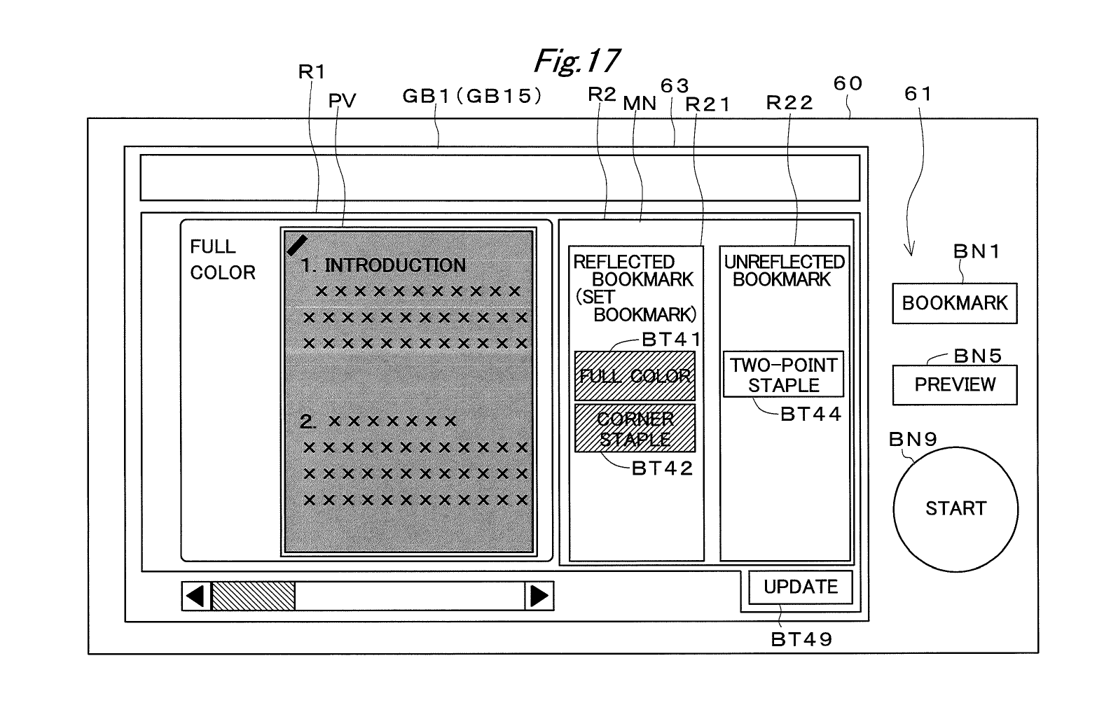

For example, as shown in FIG. 16 and FIG. 17, in the bookmark display region R2, there may be provided: a sub-region R21 for displaying the bookmark items which have undergone the mode setting, and a sub-region 22 for displaying the bookmark item which has not undergone the mode setting. On a screen GB1 (GB14) of FIG. 16, the two sub-regions R21 and R22 are displayed in line in a longitudinal direction in the bookmark display region R2, and on a screen GB1 (GB15) of FIG. 17, the two sub-regions R21 and R22 are displayed in line in a lateral direction in the bookmark display region R2.

### 3. Third Embodiment

In each of the above-described embodiments, the case has been illustrated, where “bookmark item” is registered for each of the jobs, however, the present invention is not limited to this. For example, “bookmark item” intrinsic to the image forming apparatus 1 may be registered in advance before the start of the processing target job. In the third embodiment, a description is given of such a modification example.

In the third embodiment, the case has been illustrated, where “bookmark item” intrinsic to the image forming apparatus 1, which is also “bookmark item” common to the respective users, is registered in advance by the administrator. Note that it is assumed that such a registration operation is performed in advance in response to command input by the administrator. For example, the administrator just needs to select and register desired items (“(single-sided >) double-sided” and “2-in-1” and the like) as the bookmark items on a predetermined operation screen and the like.

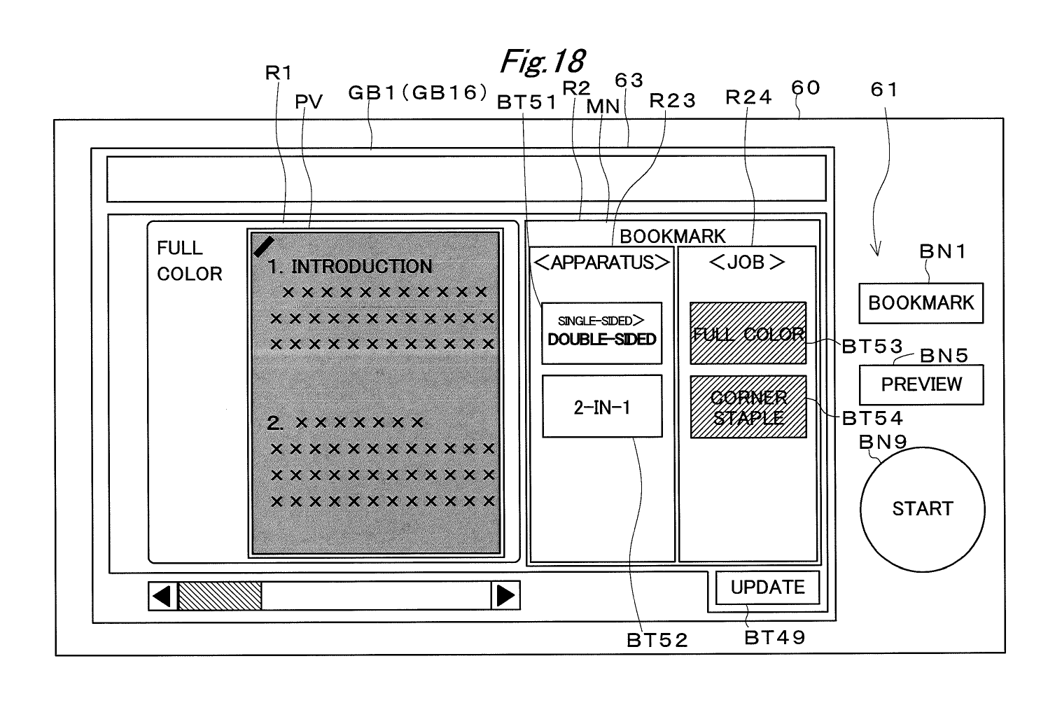

In this third embodiment, after the registration operation of the bookmark items by the administrator is ended, with regard to the above-mentioned “full color” and “corner staple”, both of the mode setting operations and the bookmark registration operations are executed based on operations by the user in a similar way to the first embodiment. Then, when the preview button BN5 is pressed down by the user, a preview-added screen GB1 (GB16) as shown in FIG. 18 is displayed on the touch screen 63 after the original reading operation is performed. Note that, also on the screen GB16, from the beginning, the case is assumed, where “upper left” is designated as the position of “corner staple”.

On this screen GB16 (FIG. 18), sub-regions R23 and R24 are provided in the bookmark display region R2.

In a similar way to the above-described first or second embodiment, the sub-region R24 is a region showing “bookmark item” decided for each job by the user. In the sub-region R24, two setting items which are “full color” and “corner staple” are displayed as “bookmark item” registered for the job by the user.

Meanwhile, the sub-region R23 is a region showing “bookmark item” registered in advance by the administrator. In the sub-region R23, two setting items which are “(single-sided >) double-sided” (also simply written as “double-sided”) and “2-in-1” are displayed as “bookmark item” registered in advance by the administrator. Note that “bookmark item” in the sub-region R23 is provided fixedly in the image forming apparatus without depending on the job, and accordingly, is also expressed as “fixed bookmark item”. Moreover, here, it is assumed that “bookmark item” (“bookmark item” in the sub-region R23) registered in advance for the image forming apparatus 1 by the administrator is not deleted by an operation of the user, and is always displayed on all of the jobs (without depending on the jobs).

Moreover, on the bookmark display region R2 of FIG. 18, setting contents reflected on the mode setting are shown by hatching. Specifically, two items (“full color” and “corner staple”) in the sub-region R24 are hatched, and it is shown that the two items in the sub-region R24 are “bookmark item” reflected on the mode setting. Meanwhile, two items (“(single-sided >) double-sided” and “2-in-1” in the sub-region R23 are not hatched, and it is shown that the two items in the sub-region 23 are “bookmark item” that is not reflected on the mode setting. Thus, immediately after the first setting operation by the user, the setting contents regarding “fixed bookmark item” (bookmark items in the sub-region R23) registered in advance in the apparatus are not still reflected on the mode setting.

The user UA is capable of allowing the image forming apparatus 1 to execute a mode re-setting operation and the like by using this screen GB16. For example, by using the fixed bookmark item “2-in-1” in the sub-region R23, it is possible to perform a setting operation (re-setting operation) for changing “1-in-1” to “2-in-1”. A description is given below of the re-setting operation.

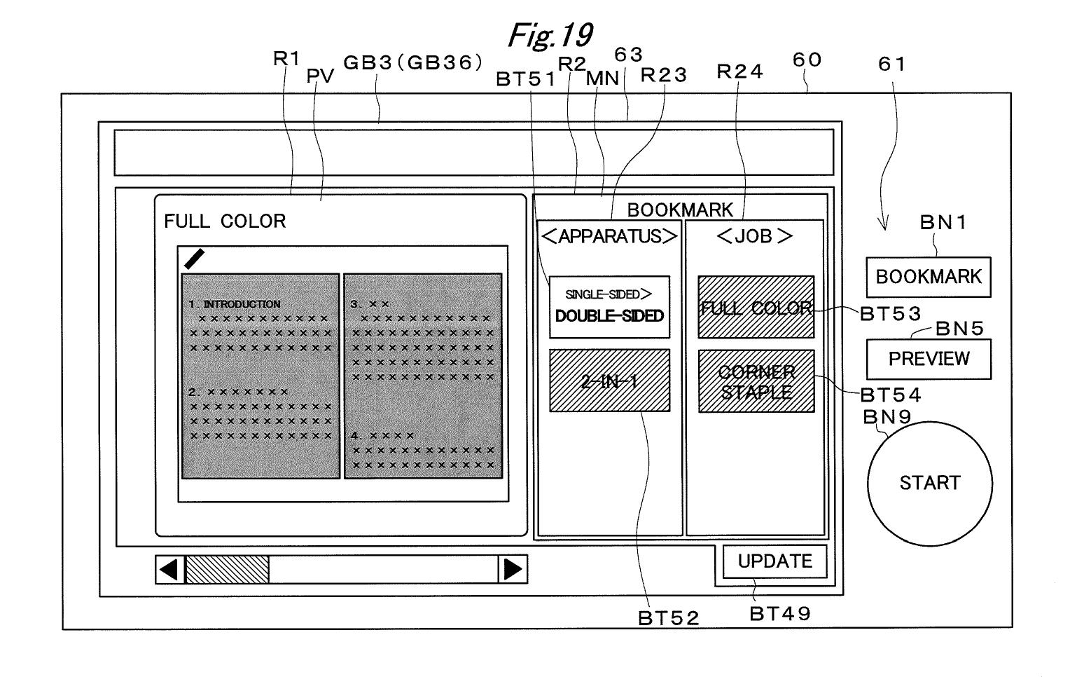

Specifically, when the fixed bookmark item “2-in-1” button BT52 in the sub-region R23 of the screen GB16 of FIG. 18 is pressed down, and thereafter, the update button BT49 is pressed down, the image forming apparatus 1 creates a (updated) preview image PV corresponding to the setting contents after the setting change. Then, the image forming apparatus 1 updates the preview image PV in the preview display region R1, and displays a screen GB3 (GB36) as shown in FIG. 19 on the touch screen 63. That is, on the screen GB36 (FIG. 19), the preview image PV after the change to “2-in-1” is shown. Therefore, the user UA can easily confirm a print output state (scheduled) after the change.

In accordance with the mode as described above, “fixed bookmark item” is registered in advance (pre-registered) in the apparatus by the administrator and the like. Accordingly, even if the “bookmark” registration operation by the user is not performed for each job, it is possible to perform the re-setting operation using the “fixed bookmark item” (“2-in-1” and the like). Therefore, it is not necessary for the user to perform the bookmark registration for each job, and accordingly, time and trouble of the user can be reduced.

Note that, in this third embodiment, the case has been illustrated, where “bookmark item” registered in advance for the image forming apparatus 1 by the administrator is not deleted by the usual operation of the user, however, the present invention is not limited to this. For example, the user may perform a customizing operation of deleting unnecessary “fixed bookmark item” by a predetermined registration deleting operation and leaving an arbitrary number of “fixed bookmark item” for the user him/herself, and may display, on the sub-region R23, the arbitrary number of “fixed bookmark item” customized for the user him/herself.

Moreover, in this third embodiment, the case has been illustrated, where “fixed bookmark item” common to the respective users is registered in advance, however, the present invention is not limited to this. For example, “fixed bookmark item” different for each user may be registered in advance. Here, in particular, it is assumed that an authentication operation by the using user is performed in the image forming apparatus 1, and that a logging-in user (login user) is identified.

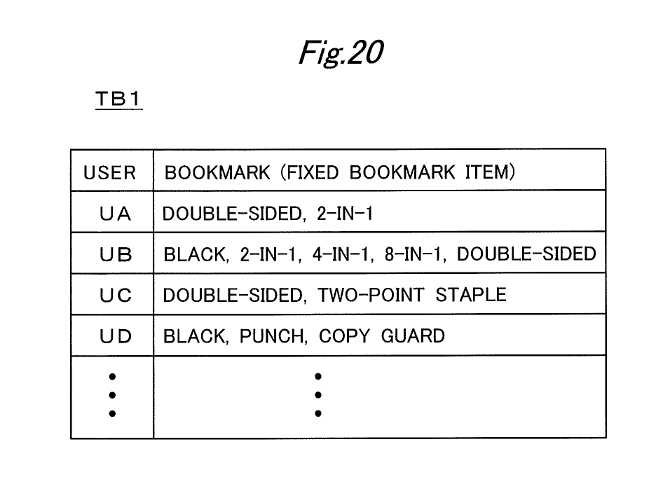

FIG. 20 is a view showing a data table TB1 in such a modification example. This data table TB1 is a data table showing registration contents of “fixed bookmark item” of each of the users, and is stored in the storage unit 5. In FIG. 20, with regard to the user UA, two items which are “(single-sided >) double-sided” (also simply written as “double-sided”) and “2-in-1” are registered as “fixed bookmark item”. Moreover, with regard to a user UB, five items which are “black”, “2-in-1”, “4-in-1”, “8-in-1” and “double-sided” are registered as “fixed bookmark item”. Furthermore, with regard to a user UC, two items which are “double-sided” and “two-point staple” are registered as “fixed bookmark item”. Also with regard to a user UD, “fixed bookmark item” intrinsic thereto is registered.

Then, based on such registration contents of “fixed bookmark item”, display contents of the sub-region R23 are changed in response to the login user. For example, in the case where the login user is the user UA, then based on the registration contents thereof (“double-sided” and “2-in-1”), the screen GB16 similar to that in FIG. 18 is displayed as the preview-added screen GB1. Meanwhile, in the case where the login user is the user UC, then based on the registration contents thereof (“double-sided” and “two-point staple”), a screen GB17 as shown in FIG. 21 is displayed as the preview-added screen GB1. Then, the user UC is capable of performing the setting change operation by using the screen GB (GB17 and the like). Note that the contents of the data table TB1 (FIG. 20) may be collectively registered by the administrator, or may be registered individually by the respective users.

In accordance with the modification example as described above, “fixed bookmark item” can be set for each user. Hence, each user sets “bookmark item”, which is frequently used by him/herself, as “fixed bookmark item”, and thereby can further enhance the operability.

Note that, here, there has been illustrated the case of registering “fixed bookmark item” intrinsic to each user, however, the present invention is not limited to this, and “fixed bookmark item” intrinsic to a division to which each user belongs may be registered.

### 4. Fourth Embodiment

In each of the above-described embodiments, the case has been illustrated, where “bookmark item” is registered by the registration operation by the user or the administrator (that is, a manual operation), however, the present invention is not limited to this. For example, “bookmark item” may be automatically registered in the image forming apparatus 1. In this fourth embodiment, such a modification example is illustrated. Specifically, the case has been illustrated, where two types of items (in detail, “original setting direction (orientation of original)” and “binding direction”) have automatically undergone the mode setting by the image forming apparatus 1 are automatically registered as “bookmark item” in the case where the operator performs the mode setting for “two-point staple”. In other words, the case has been illustrated, where two types of setting items of which setting contents are decided by an automatic setting operation (automatic mode setting operation) in the image forming apparatus 1 are decided as target items for the re-set, and are registered as bookmarks. In short, a description is given of the case where the target items (setting items) of the automatic mode setting are registered as “bookmark item” in the case where the setting items related to the mode setting items by the operator undergo such automatic mode setting.

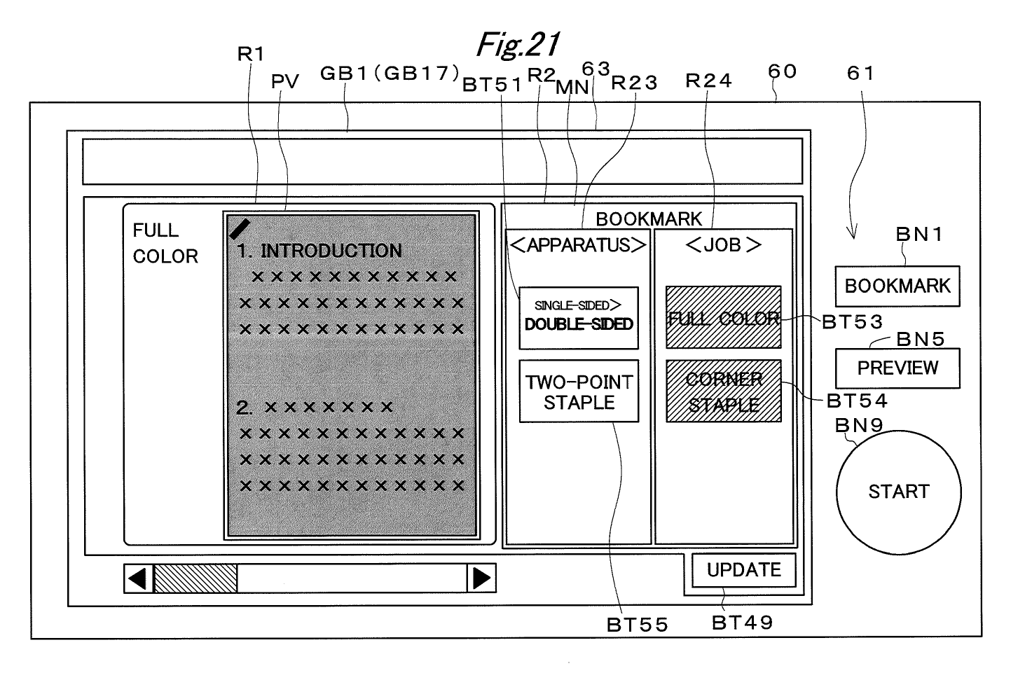

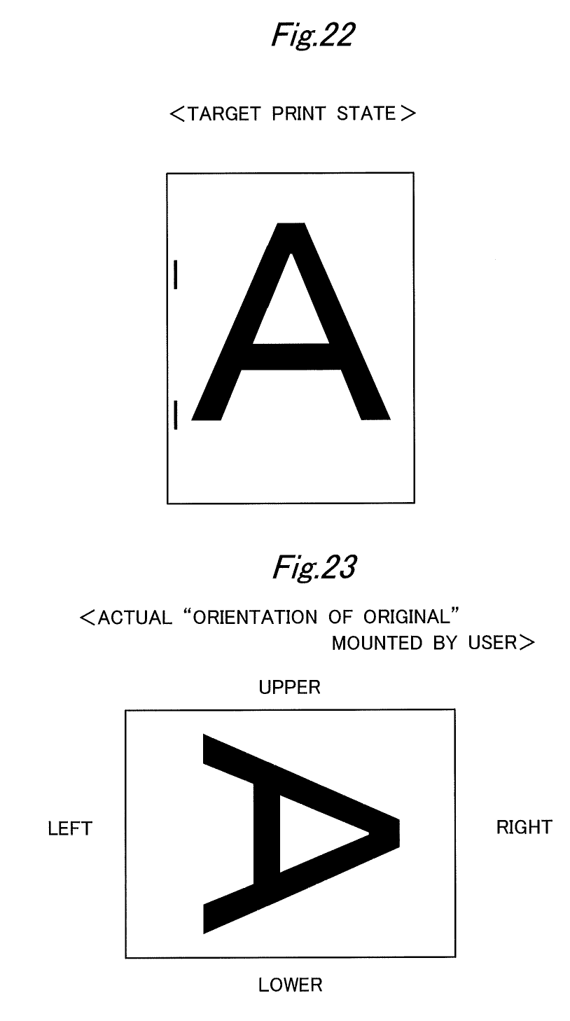

First, while referring to FIG. 22 to FIG. 26, a description is given of operations in which the user performs the mode setting for “two-point staple” and executes a copy job, and of problems which may occur in the operations. Note that, in FIG. 22 to FIG. 26, “orientation of original” is expressed by using an alphabet “A”. Moreover, in FIG. 22 to FIG. 26, actual “orientation of original” (actual orientation) is represented by “A” with a dense color (black), and “orientation of original” (assumed orientation) assumed by the image forming apparatus is represented by “A” with a dimmed color (gray).

FIG. 22 is a view showing a target print output state by the user UA. Here, as shown in FIG. 22, it is assumed that the user UA desires to implement “two-point staple” on the left side of a vertically oriented original (in detail, a duplication thereof).

Moreover, in this fourth embodiment, when the mode setting of “two-point staple” is executed in response to the operation of the user, it is assumed that the image forming apparatus 1 further automatically executes mode setting regarding “original setting direction (orientation of original)” and “binding direction”. Specifically, with regard to “original setting direction”, it is assumed that, from among four options which are “upward (0 degrees)”, “downward (180 degrees)”, “leftward (270 degrees)” and “rightward (90 degrees)”, “upward (0 degrees)” is always automatically selected, and the mode setting is performed. Note that each “setting direction of original” can also be expressed by a rotation angle (for example, 0 degrees, 90 degrees, 180 degrees or 270 degrees clockwise) which takes a state of FIG. 22 as a reference. Moreover, with regard to “binding direction”, it is assumed that, from among three options which are “upper binding”, “left binding” and “right binding”, “left binding” is always automatically selected, and the mode setting is performed.

Thus, when the mode setting of “two-point staple” is performed by the user UA, the image forming apparatus 1 automatically sets “setting direction of original” at “upward, and in addition, automatically sets “binding direction” at “left binding”. Then, based on these pieces of mode setting, a print out (copy output) operation is executed.

Incidentally, in the case where the user UA mounts the original on the auto document feeder (ADF) of the image forming apparatus 1 in the same direction as in FIG. 22, the image forming apparatus 1 implements staple processing individually at two points (in detail, upper left portion and lower left portion) on the left side of the vertically oriented original, and thereby outputs a target printed and outputted matter as shown in FIG. 22. In this case, the image forming apparatus 1 automatically and accurately recognizes “original setting direction (orientation of original)” and “binding direction”, and appropriate mode setting is performed. Accordingly, the printed and outputted matter as the target is appropriately printed and outputted. The user UA can obtain an appropriate printed and outputted matter without performing detailed setting operations, and accordingly, can obtain extremely high operability.

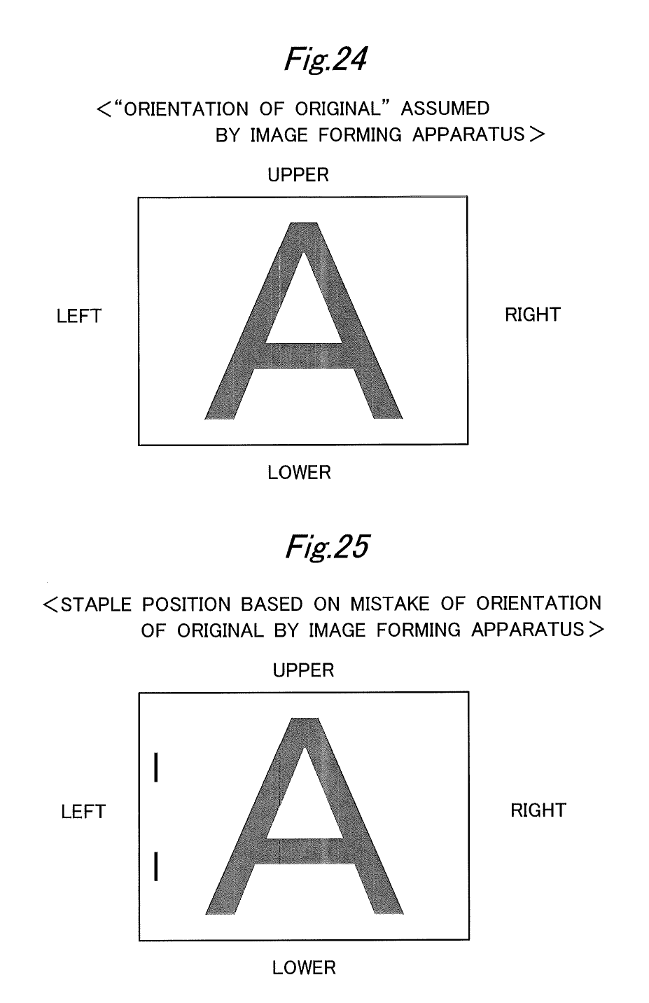

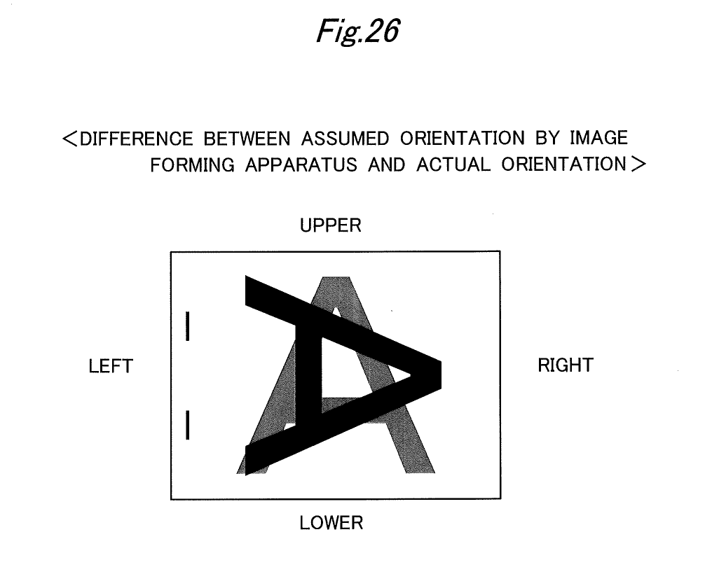

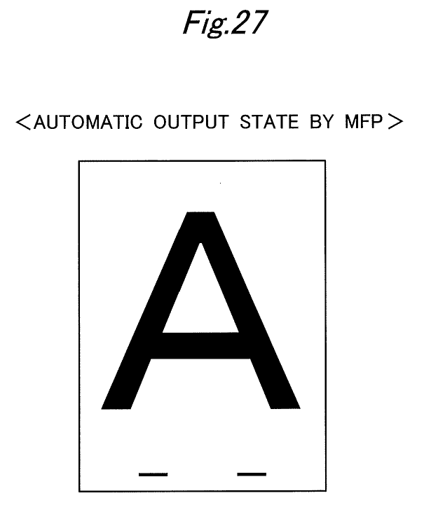

However, as shown in FIG. 23, in the case where the user UA mounts the original on the auto document feeder (ADF) of the image forming apparatus 1 in a different orientation from that in FIG. 22 (specifically, orientation rotated clockwise by 90 degrees), the image forming apparatus 1 mistakes the orientation of the original. Specifically, though the actual orientation on the ADF is “rightward (90 degrees)” (FIG. 23), the image forming apparatus 1 automatically sets “setting orientation of original” at “upward”, and recognizes that the orientation of the original is “upward (0 degrees)” (FIG. 24). Then, based on this result of the mistake (FIG. 24) taken as the premise, as shown in FIG. 25, the image forming apparatus 1 implements the staple processing at two positions on “left side (left side of dimmed color “A”). However, as shown in FIG. 26, the positions which have undergone the staple processing are actually on “lower side” (lower side of dense color “A”) of the original. Therefore, though the image forming apparatus 1 assumes the print output state as shown in FIG. 25, a printed and outputted matter (printed and outputted matter in which two-point staple is implemented on lower side of original) as shown in FIG. 27 is actually obtained.

This fourth embodiment illustrates a technology for making it possible to easily change the mode setting in order to avoid such a situation. Specifically, in the case where the operator performs the mode setting for “two-point staple”, the image forming apparatus 1 automatically decides setting contents of two types of items (“original setting direction (orientation of original)” and “binding direction”) by the automatic setting operations, and in addition, automatically registers the two types of items as “bookmark item”. The user can easily perform such mode setting change operations by using the automatically registered “bookmark item” (for example, bookmark item “original setting direction”).

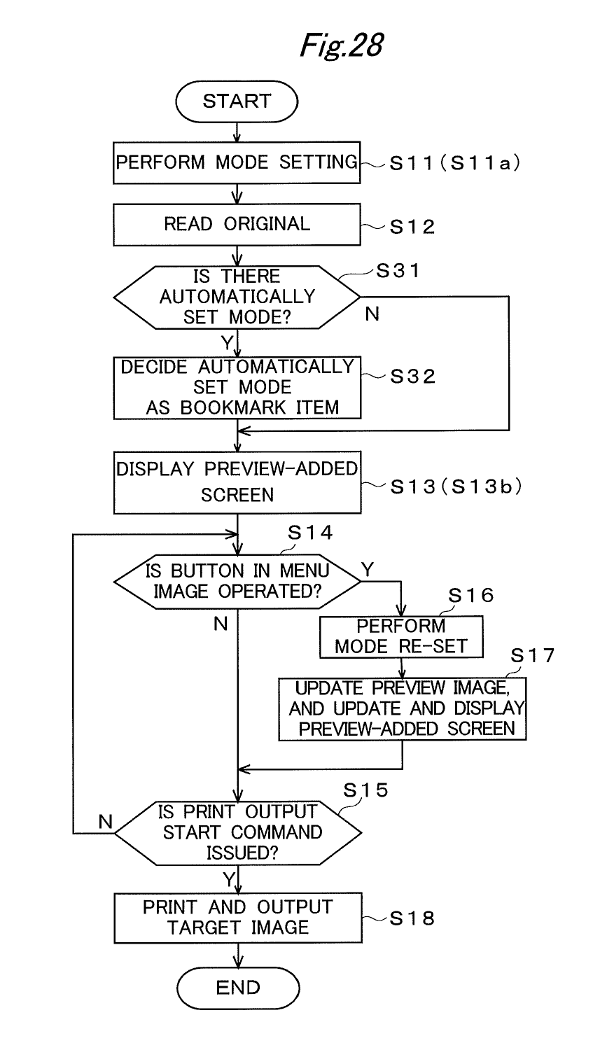

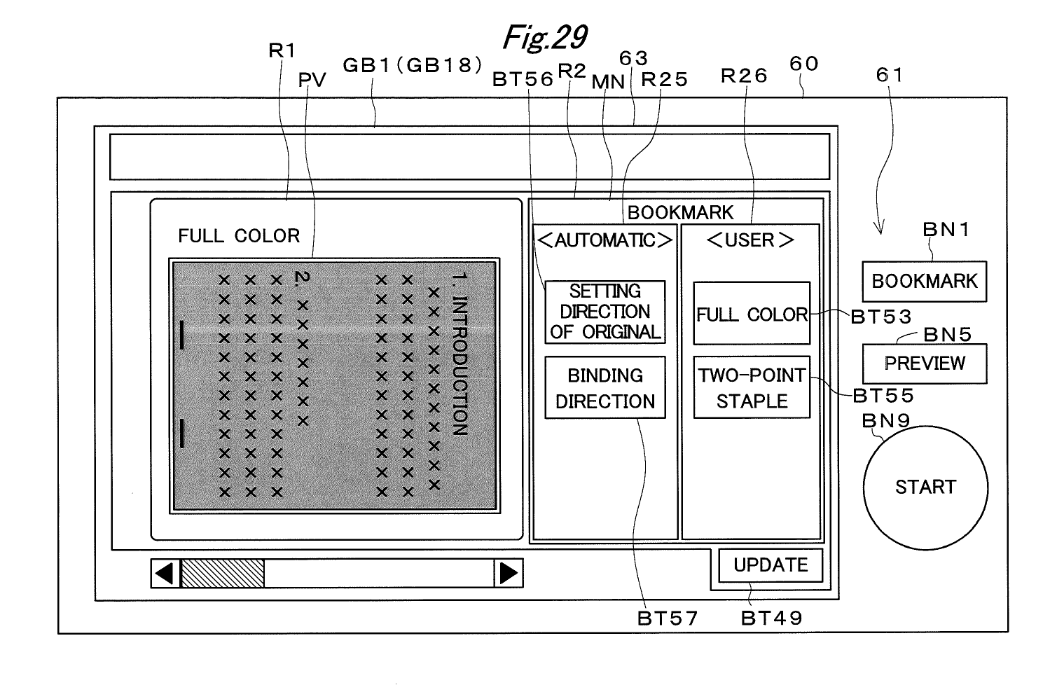

FIG. 28 is a flowchart showing operations according to the fourth embodiment. A description is given of a detailed operation example while referring to FIG. 28. FIG. 28 is basically similar to FIG. 2, however is different therefrom in that processing of steps S31 and S32 is executed between step S12 and step S13, and so on. A description is mainly given below of different points.

First, in step S11, the mode setting operations and the like are executed.

Specifically, when the user UA presses down the bookmark registration button BN1 (FIG. 3), the image forming apparatus 1 regards such a pressing operation for the bookmark registration button BN1 as the start command of “bookmark registration processing”, and starts to accept the registration operation of the bookmark. Thereafter, in a similar way to the above-described first embodiment, it is assumed that the user performs the mode setting operation regarding “full color”, and further, performs the mode setting operation regarding “two-point staple”. In response to the mode setting operations by the user, the image forming apparatus 1 individually executes the bookmark registration operations and the mode setting operations with regard to “full color” and “two-point staple”.

Here, in response to the mode setting operation for “two-point staple” by the user UA, the image forming apparatus 1 additionally (and automatically) executes the mode setting regarding “original setting direction (orientation of original)” and “binding direction”. Specifically, as mentioned above, the image forming apparatus 1 automatically sets “setting direction of original” at “upward”, and in addition, automatically sets “binding direction” at “left binding”. Thus, the mode setting operation regarding “two-point staple” is accompanied with the additional automatic mode setting operations. Therefore, the mode setting operation regarding “two-point staple” is also expressed as “automatic setting-accompanying operation”. Note that, in the case where an error is present in such recognition contents in the automatic mode setting operations, problems as mentioned above occur.

After ending the setting operations regarding the two items (“full color” and “two-point staple”) in the manner as described above, the user UA mounts the original on the auto document feeder (ADF), and presses down the preview button BN5. Here, it is assumed that the preview button BN 5 is pressed down in a state where the original is mounted rightward on the auto document feeder (ADF) (see FIG. 23).

In response to the pressing operation for the preview button BN5, the image forming apparatus 1 optically reads the original, and creates the image for copy (step S12).

In the next step S31, the image forming apparatus 1 determines whether or not “automatic setting-accompanying operation” is performed in the mode setting operations in step S11. For example, it is determined that the mode setting operations regarding “two-point staple” are “automatic setting-accompanying operation” regarding “original setting direction” and “binding direction”.

Then, in the case where it is determined that “automatic setting-accompanying operation” is performed in the mode setting operations (step S11), the processing proceeds from step S31 to step S32. Meanwhile, in the case where it is determined that “automatic setting-accompanying operation” is not performed, the processing directly proceeds to step S13 without passing through step S32.

In step S32, the image forming apparatus 1 automatically registers, as “bookmark item”, setting items corresponding to “automatic setting-accompanying operation”. Specifically, with regard to “two-point staple”, the two setting items (“original setting direction” and “binding direction”) are automatically registered as “bookmark item”. In other words, the two setting items of which setting contents are decided by the automatic setting operations in the image forming apparatus 1 are decided and registered as the target items (“bookmark item”) for the re-set.

Then, in step S13 (S13b), the preview-added screen GB1 (GB18) (FIG. 29) is displayed on the touch screen 63.

On the preview image PV in the preview display region R1 of this preview-added screen GB18, it is shown that “full color” setting and “two-point staple” setting are made.

Moreover, on the bookmark display region R2 of the preview-added screen GB18, sub-regions R25 and R26 are provided. The sub-region R26 is a region for displaying “bookmark item” decided for each job by the user. In FIG. 29, on the sub-region R26, two setting items which are “full color” and “two-point staple” are displayed as “bookmark item” registered for the job by the user. Meanwhile, the sub-region R25 is a region for displaying “bookmark item” automatically registered as setting items corresponding to “automatic setting-accompanying operation”. On the sub-region R25, two setting items which are “original setting direction” and “binding direction” are registered as “bookmark item” registered automatically.

As shown in FIG. 29, this preview image PV is an image different from the image of the target printed and outputted matter intended by the user UA. This results from that the image forming apparatus cannot correctly recognize that the user UA mounts the original rightward on the auto document feeder (ADF) as mentioned above. That is, this results from that an error is present in the automatic setting contents related to “two-point staple” (automatic setting-accompanying operation”).

Thereafter, operations similar to those of step S14 and after are executed.

When the user UA views the preview image PV, and determines that the error is present in the automatic setting contents of the two setting items (“setting direction of original” and “binding direction”) related to “two-point staple”, the user UA can execute the mode setting operations by using “bookmark item” in the menu image MN of the bookmark display region R2. Meanwhile, when the user UA views the preview image PV and determines that the automatic setting contents are correct, the user UA directly presses down the start button BN9.

A description is further given blow of the case where the user UA determines that the error is present in the automatic setting contents by the image forming apparatus 1 with regard to “two-point staple”.

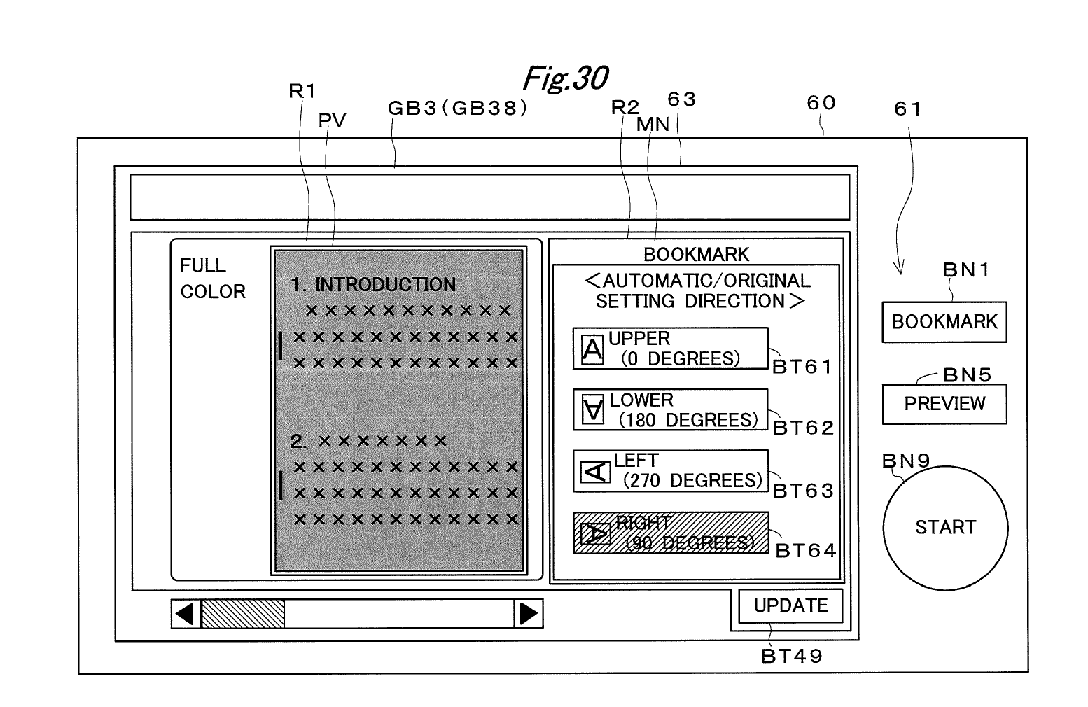

When the user UA presses down the “original setting direction (orientation of original)” button BT56 (FIG. 29), then in response to the pressing operation, the image forming apparatus 1 displays a detail setting image (new menu image MN) of the setting item, which corresponds to the button BT 56 as the pressing target, on the bookmark display region R2. Specifically, a menu image MN (see FIG. 30) for the detail setting regarding “setting direction of original” is displayed on the bookmark display region R2. In detail, a menu image MN having buttons for setting “original setting direction” are displayed on the bookmark display region R2. These buttons are an “upper (0 degrees)” button BT61, a “lower (180 degrees)” button BT62, a “left (270 degrees)” button BT63, and a “right (90 degrees)” button BT64.

Moreover, the user UA can perform the setting change operation by using this detail setting image. For example, the user UA can perform the setting change (mode re-setting) for “original setting direction” from “upper (0 degrees)” to “right (90 degrees)”. In detail, the user UA presses down the “right” button BT64, thereby sets “right” at a selected state (and sets “upper” at a non-selected state), and thereafter, presses down the “update” button BT49. In such a way, the re-setting operation (step S16) regarding the bookmark item “original setting direction” is performed.

In response to the pressing operation for the “update” button BT49, the image forming apparatus 1 updates the preview image PV based on the setting contents (setting contents after re-set regarding rest items) after the setting change operation, and displays the updated preview image PV on the preview display region R1 (step S17). As a result, an updated screen GB3 (GB38) as shown in FIG. 30 is displayed on the touch screen 63. On the updated preview image PV, the positions of the two-point staple are changed from “lower side” to “left side” in the original. The user UA visually recognizes the preview image PV in the screen GB3, and can thereby confirm that the positions of the two-point staple are appropriately changed.

Thereafter, when the start button BN9 is pressed down at appropriate timing, the processing target image is printed and outputted based on the re-set setting contents (step S18). As a result, the user UA can obtain the printed and outputted matter in the target print output state as shown in FIG. 22.

Thus, on the preview-added screen GB18 (FIG. 29), the two setting items (“original setting direction” and “binding direction” automatically set in relation to “two-point staple” are automatically displayed as “bookmark item”. Hence, the user UA is capable of easily performing the setting change by using the registered “bookmark item” without requiring time and trouble for the self-registration. In other words, it is possible for the user to easily change the contents of the setting items automatically set by the image forming apparatus. In particular, it is possible for the user to easily correct the mistake made by the image forming apparatus.

Note that, the case has been illustrated above, where the mode setting operations and the bookmark registration operations are executed in step S11, however, the present invention is not limited to this. For example, only the mode setting operations may be performed in step S11. Specifically, with regard to “full color” and “two-point staple”, only the mode setting operations may be executed, and the bookmark registration operations do not have to be executed. Then, the automatic registration operations (steps S31, S32) for “bookmark item” (“original setting direction” and “binding direction”) related to the automatic setting item (“two-point staple”) may be performed. In this case, the buttons in the sub-region R26 (or the sub-region R26 itself) are not displayed in FIG. 29, however, the buttons BT56 and BT57 in the sub-region R25 are displayed in a similar way to the above-described fourth embodiment. Hence, it is possible to obtain similar effects to those of the above-described fourth embodiment.

### 5. Modification Example Etc.

The description has been given above of the embodiments of the present invention, however, the present invention is not limited to the contents described above.

<Expected Degree of Use (Expected Usage Frequency>

For example, in each of the above-described first embodiment and second embodiment, the case where the bookmark registration is manually performed by the user has been illustrated. In such a case, a plurality of “bookmark item” may be classified and registered based on a predetermined criterion, and in accordance with a result of the classification, the plurality of “bookmark item” may be classified and displayed in the menu image MN of the preview-added screen GB1 (also written as GB4) (see FIG. 32). As such a classification criterion, an expected degree of use by the user (that is, an expected value of a usage frequency by the user) or the like is illustrated. This “expected degree of use” is also expressed as an expected value of a usage frequency, an expected usage frequency and the like.

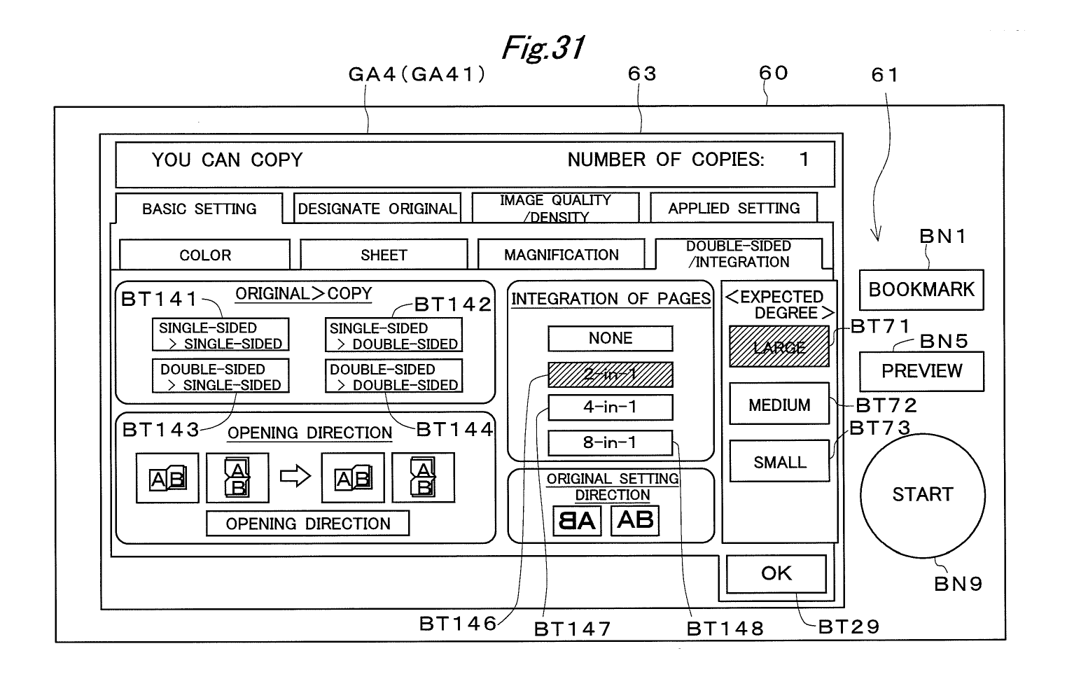

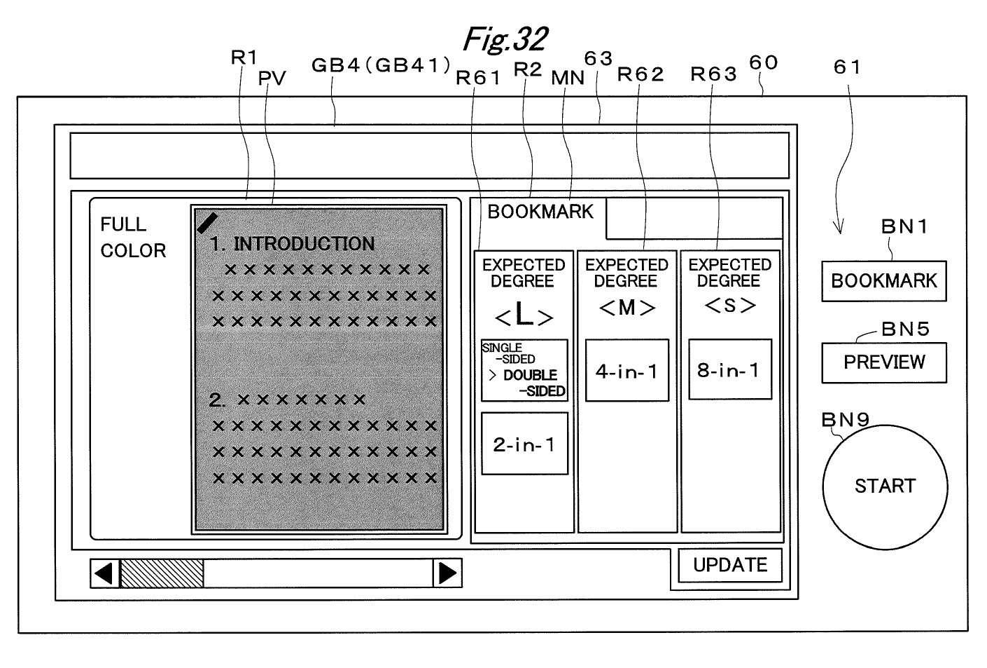

FIG. 31 is a view showing a registration screen GA4 (GA41) according to the modification example as described above, and FIG. 32 is a view showing the preview-added screen GB4 (GB41) according to the modification example.

The registration screen GA4 (FIG. 31) is a screen displayed on the touch screen 63 in response to pressing of a “double-sided/integration” button BT14 (FIG. 3) of the screen GA1.

On this screen GA4, buttons for a variety of mode setting such as “double-sided” “2-in-1”, “4-in-1” and “8-in-1” are provided. The user is capable of performing the variety of mode setting by using the screen GA4. Specifically, subsequently to the setting item button, the user presses down any of expected degree designation buttons (“large (L)”, “medium (M)”, “small (S)”) BT71, BT72 and BT73 provided in the screen GA4, and then presses down the OK button. In such a way, the user sets (mode setting) the setting item corresponding to the setting item button, and registers the setting item also as “bookmark item”. Moreover, when “bookmark item” is registered, the expected degree of use, which is based on such designation contents by any of the expected degree designation buttons BT71 to BT73, is registered in relation to the bookmark item.

Specifically, a “(single-sided >) double-sided” button BT142, the expected degree “large” button BT71, and the OK button BT29 are pressed down, whereby the item “double-sided” is classified and registered as an item in which the expected degree of use is “large”. Moreover, the “2-in-1” button BT146, the expected degree “large” button BT71, and the OK button BT29 are pressed down, whereby the item “2-in-1” is classified and registered as an item in which the expected degree of use is “large”. In a similar way, the “4-in-1” button BT147, the expected degree “medium” button BT72 and the OK button BT29 are pressed down, whereby the item “4-in-1” is classified and registered as an item in which the expected degree of use is “medium”. Moreover, the “8-in-1” button BT148, the expected degree “small” button BT73 and the OK button BT29 are pressed down, whereby the item “8-in-1” is classified and registered as an item in which the expected degree of use is “small”. In such a way, the plurality of “bookmark item” is classified and registered in accordance with the expected degree of use (expected usage frequency).

Then, after the preview button BN5 is pressed down, the preview-added screen GB4 (GB41) as shown in FIG. 32 is displayed on the touch screen 63. In the bookmark display region R2 of this screen GB41, the two bookmark items (“double-sided” and “2-in-1”) are classified and displayed as the expected degree “large”, the bookmark item “4-in-1” is classified and displayed as the expected degree “medium” and the bookmark item “8-in-1” is classified and displayed as the expected degree “small”. In detail, the bookmark items in which the expected degrees are “large” are displayed on a sub-region R61, the bookmark item in which the expected degree is “medium” is displayed on a sub-region R62, and the bookmark item in which the expected degree is “small” is displayed on the sub-region R63. Thus, in the bookmark display region R2 (in detail, the menu image MN), the plurality of “bookmark item” is classified and displayed in accordance with the expected usage frequency.

The user can perform the setting change operations regarding the processing target image by using these bookmark items, and can immediately confirm a result of the setting changes on the preview image PV. In particular, “bookmark item” as the setting items for the re-set is classified in accordance with the expected degrees of use (expected usage frequencies), and accordingly, it is easy for the user to find desired “bookmark item”.

Note that, here, the case has been illustrated, where “bookmark item” corresponding to “expected degree of use” is manually registered by the user simultaneously with the mode setting, however, the present invention is not limited to this. Such classification/registration operations as described above regarding “bookmark item” may be executed in advance by the user before the execution of the job. For example, at a predetermined point of time before the execution of the copy job (in detail, at the point of initial registration time or the like), a predetermined registration screen (screen similar to that of FIG. 31) may be called up in response to a predetermined operation by each user, and the classification/registration operations may be performed in advance prior to the copy job. Moreover, when the copy job is thereafter executed, a preview-added screen GB4 similar to that of FIG. 32 may be displayed in response to the pressing of the preview button BN5, or the like. In accordance with this, the classification/registration results of the plurality of classified and registered “bookmark item” (“fixed bookmark item”) are usable commonly to a plurality of jobs. In particular, in such a case, it is not necessary to perform the classification/registration operations for each job, and accordingly, it is possible to appropriately use the plurality of “bookmark item” corresponding to “expected degree of use” while reducing time and trouble for the registration. In particular, it is possible for the user to find the desired “bookmark item” by effectively using “expected degree of use” displayed commonly to the plurality of jobs.

Moreover, here, the case where “bookmark item” corresponding to “expected degree of use” is registered by the user has been illustrated, however, the present invention is not limited to this. For example, “bookmark item” corresponding to “expected degree of use” may be registered by the administrator. In this case, it is not necessary for the user to register the bookmarks for each job, and accordingly, the time and trouble of the user can be reduced.

<Resource Saving Bookmark>

Moreover, in the above-described third embodiment or the like, the case has been illustrated, where “bookmark item” (fixed bookmark item) intrinsic to the image forming apparatus 1 is registered in advance in the image forming apparatus by the administrator and the like before the start of the processing target job. As such “fixed bookmark item”, setting items which contribute to resource saving may be registered in advance. For example, the setting items such as “double-sided”, “2-in-1”, “4-in-1” and “8-in-1”, which reduce the usage number of printing sheets and contribute to the resource saving, may be registered in advance as “resource saving promoting bookmark item” and the like in the image forming apparatus 1. Alternatively, a setting item such as “black”, which reduces a total usage amount of toner and contributes to the resource saving, may be registered in advance as “resource saving promoting bookmark item” and the like in the image forming apparatus 1. Note that the bookmark items as described above, which contribute to the resource saving, are also referred to as “resource saving promoting bookmark item” and the like.

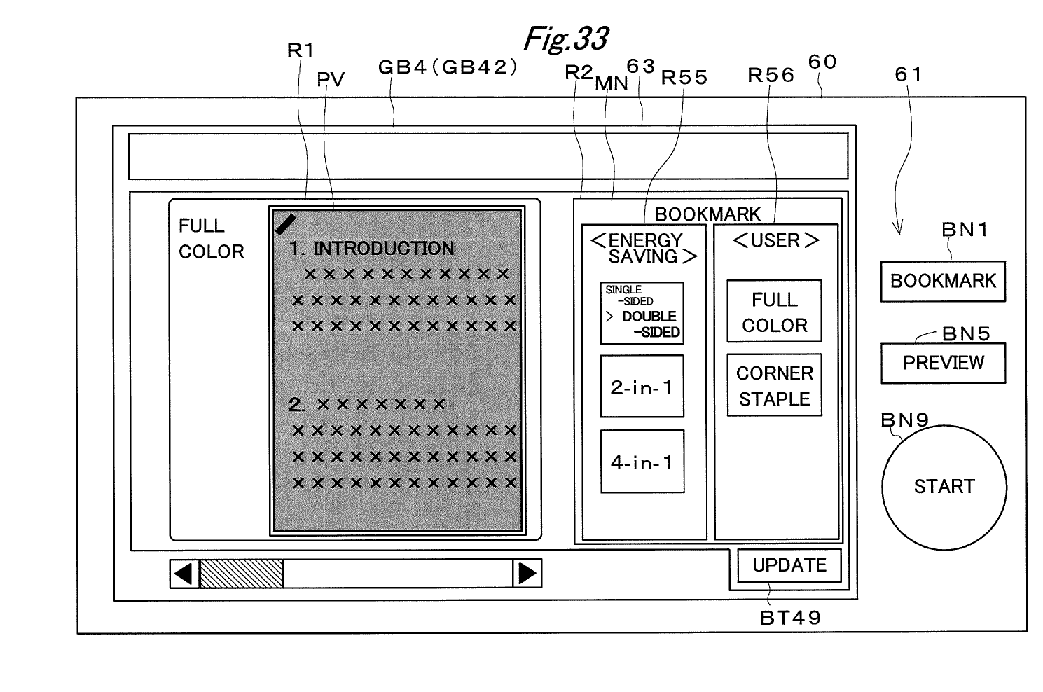

FIG. 33 is a view sowing a preview-added screen GB4 (GB42) in which “resource saving promoting bookmark item” as described above is displayed in the bookmark display region R2. Here, it is assumed that “resource saving promoting bookmark item” registered in the image forming apparatus 1 is always displayed on the preview-added screen GB42.

The screen GB42 of FIG. 33 has sub-regions R55 and R56 in the bookmark display region R2.

The sub-region R56 is a region showing “bookmark item” decided for each job by the user in a similar way to the above-described first or second embodiment or the like. On the sub-region R56, the two setting items which are “full color” and “corner staple” are displayed as “bookmark item” registered for the job by the user.

Meanwhile, the sub-region R55 is a region showing “resource saving promoting bookmark item” registered in advance in the apparatus 1. On the sub-region R55, three setting items which are “(single-sided >) double-sided”, “2-in-1” and “4-in-1” are displayed as “resource saving promoting bookmark item” (in FIG. 33, written as <energy saving>).

By using this screen GB42, the user UA is capable of allowing the image forming apparatus 1 to execute the mode re-setting operations and the like. For example, it is possible to perform the setting operation (re-setting operation) for changing “1-in-1” to “4-in-1” by using “4-in-1” as “resource saving promoting bookmark item” in the sub-region R55.

In accordance with this, the user can easily execute the setting change operations by using “resource saving promoting bookmark item”, and can promote the resource saving. In particular, since “resource saving promoting bookmark item” is registered as the bookmarks in advance, it is not necessary for the user to register the bookmarks for each job at the time of using “resource saving promoting bookmark item”. Accordingly, the time and trouble of the user are reduced.

Note that, here, the case has been illustrated, where “resource saving promoting bookmark item” is registered in advance in the image forming apparatus 1, and is always displayed on the screen GB1, however, the present invention is not limited to this. For example, whether or not to display “resource saving promoting bookmark item” may be switched in response to a request from the user. Specifically, “resource saving promoting bookmark item” does not have to be displayed on the screen GB1 at the initial setting, and “resource saving promoting bookmark item” may be displayed on the screen GB1 in response to a predetermined operation (pressing operation for an energy saving mode button (not shown) of the image forming apparatus 1, and the like). In other words, “resource saving promoting bookmark item” may undergo “bookmark registration” in response to the predetermined operation (pressing operation for the energy saving mode button (not shown) of the image forming apparatus 1, and the like). In particular, it is preferable that a plurality of “resource saving promoting bookmark item” be collectively registered and displayed in response to the operation.

As descried above, whether or not to display “resource saving promoting bookmark item” is switched in response to the operation input by the user. In accordance with this, the will of the user can be reflected. In particular, in the case where the user does not desire the presence of a large number of “bookmark item”, it is also possible to suppress the number of bookmark items in the menu image MN.

<Use of Bookmark History Information>

Moreover, a selection method of “bookmark item” is not limited to those mentioned above. For example, bookmark information (also referred to as bookmark history information or registration history information) registered and used in the past may be used in a new job. Note that it is assumed below that bookmark history information MA regarding a plurality of the bookmark items is updated for each execution of the job and is recorded in the storage unit 5. Then, there is illustrated the case where, at the time of executing a certain job JB0 after execution of a plurality of jobs, the re-setting operation and the like are performed by using bookmark history information (bookmark information in the past) regarding the plurality of jobs.

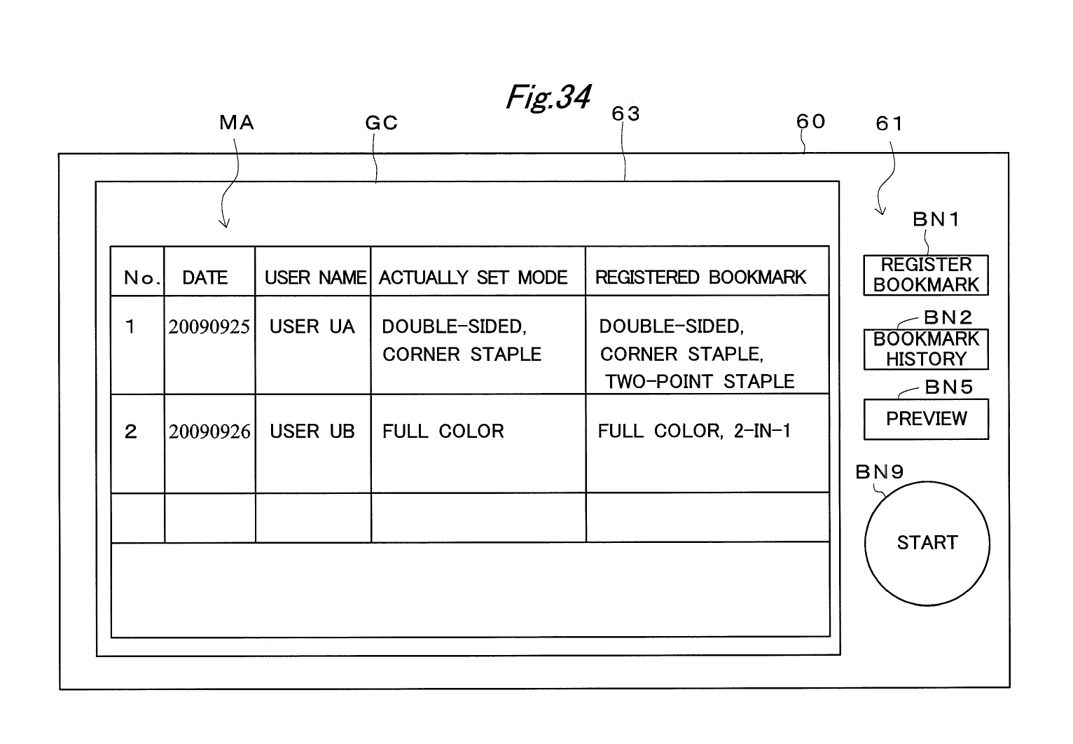

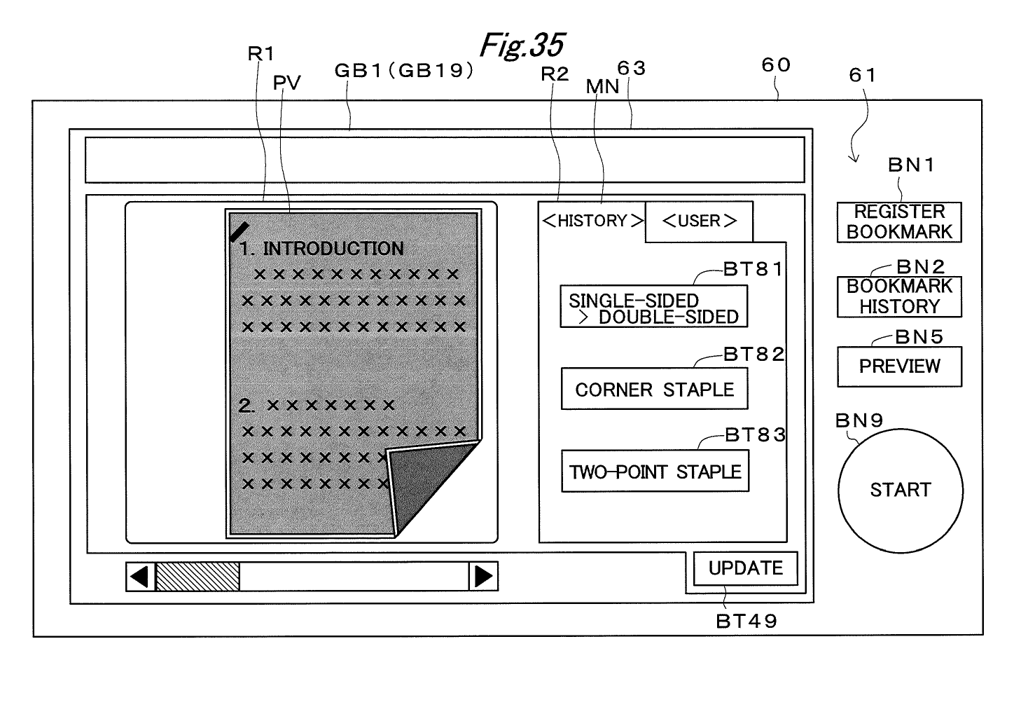

Specifically, at the time when the certain job JB0 is executed after the execution of the plurality of jobs, the user UA first presses down a bookmark history button BN2 (FIG. 34) in the operation panel unit 60. Then, the image forming apparatus 1 displays a history information display screen GC including the bookmark history information MA on the touch screen 63.

FIG. 34 is a view showing the bookmark history information MA and the like. As shown in FIG. 34, the bookmark history information MA has history information of the plurality of jobs executed following the “bookmark” registration operations by each user of the image forming apparatus 1. Specifically, for each job, there are recorded a date when the job was executed, a name of the user who executed the job, a name of the mode actually set in the job, a name of the book item registered in the job, and the like.

For example, on the uppermost stage (“No. 1”) of the bookmark history information MA of FIG. 34, a job executed by the user UA on Sep. 25, 2009 is shown. Moreover, in the job, the following are described: three bookmark items which are “double-sided”, “corner staple” and “two-point staple” were registered, among them, the mode setting was actually performed for two bookmark items (“double-sided” and “corner staple”), and the job was executed by using setting contents of the mode setting.

In a similar way, on a second stage (“No. 2”) of the bookmark history information MA, a job executed by the user UB on Sep. 26, 2009 is shown. Moreover, in the job, the following are described: two bookmark items which are “full color” and “2-in-1” were registered, and the job was actually executed by using the mode setting contents of one bookmark item “full color” between the two bookmark items.

Thus, on the history information display screen GC, the history information of the plurality of jobs, which is included in the bookmark history information (registration history information), is displayed. Then, as will be mentioned next, designation input of a reference job as a job to be referred to among the plurality of jobs is accepted by using the history information display screen GC.

Specifically, the user browses the bookmark history information MA, and selects, as the reference job, a job (JB1 or the like) approximate to desired setting. More in detail, the user executes a selection operation of searching and selecting the job JB1 similar to the job JB0 as the execution target from the bookmark history information MA.

For example, the case is assumed, where the user UA remembers executing the job JB1, which is similar to the job JB0 to be executed at present, for him/herself a little before (on Sep. 25, 2009 or the like). In this case, the user UA searches the similar job (job of “No. 1” or the like in the bookmark history information MA) JB1 from the bookmark history information MA and selects the searched similar job as the reference job based on his/her memory. Then, the user UA presses down a bookmark column of No. 1 of the touch screen 63. Thereafter, when the user UA further presses down the preview button BN5, the image forming apparatus 1 reads the original mounted on the auto document feeder (ADF), and displays a screen GB1 (GB19) as shown in FIG. 35 on the touch screen 63.

On the screen GB19, a preview image PV that is based on mode setting contents actually set in the reference job JB1 in the job history is created and displayed. Here, it is assumed that the image forming apparatus 1 applies the mode setting (“double-sided” and “corner staple”), which is set in the reference job JB1, also to the job JB0. Moreover, the image forming apparatus 1 displays three bookmark items (“double-sided”, “corner staple”, “two-point staple” (in detail, buttons BT81, BT82, BT83), which are registered in the reference job JB1, in a menu screen MN of the screen GB19.

Thereafter, based on the preview image PV, the user can confirm whether or not the desired contents are set. In the case where desired setting contents regarding the current job JB0 are completely the same setting contents as setting contents of the job JB1 in the past, the user UA directly presses down the start button BN9 without changing anything, and can thereby obtain desired printed and outputted matter.

Meanwhile, in the case where the desired setting contents regarding the current job JB0 are partially different from the setting contents of the job JB1 in the past, the user UA is capable of executing the re-setting operations by using “bookmark item” in the menu image MN. In other words, the user UA is capable of using the similar setting contents based on the history information.

For example, the bookmark item “two-point staple” is used, thus making it possible to execute re-setting operations similar to those of the second embodiment. Alternatively, the bookmark item “double-sided” is used, thus also making it possible to execute re-setting operations as below.

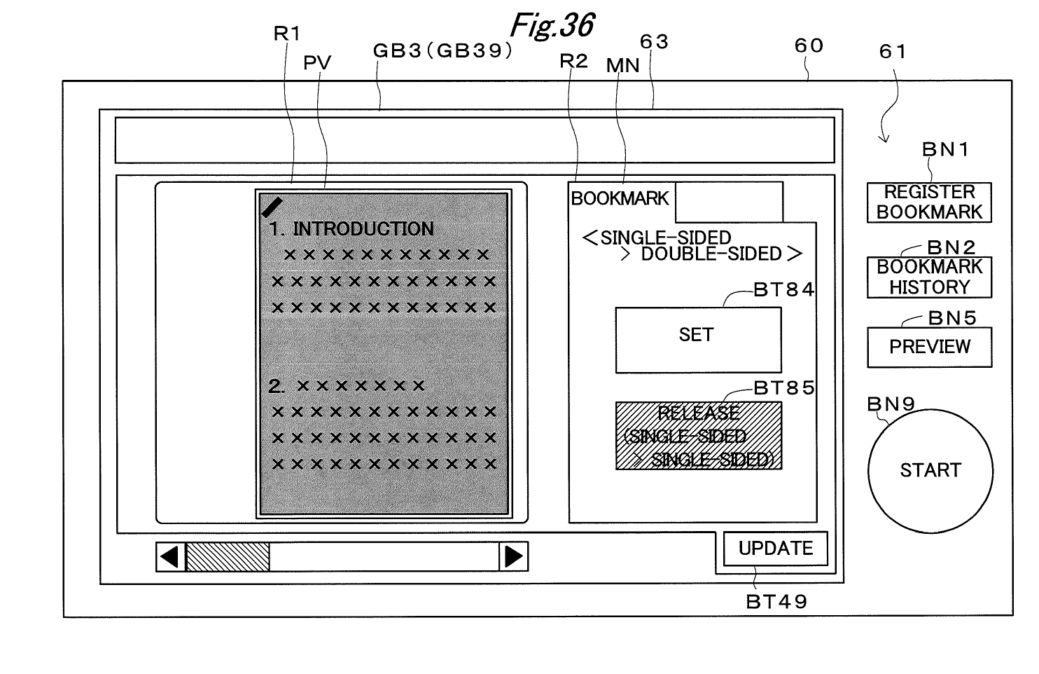

Specifically, when the user UA presses down the bookmark item “double-sided” button BT81 in the bookmark display region R2, the image forming apparatus 1 updates the menu image MN in the screen GB. Specifically, a menu image MN (see FIG. 36) having a “setting” button BT84 for performing the mode setting for “double-sided” and a “release” button BT85 for releasing the mode setting for “double-sided” is displayed on the touch screen 63. Note that the preview image PV is not still updated at this point of time.

Then, when the user UA presses down the release button BT85, and further presses down the update button BT49, the image forming apparatus 1 creates a (updated) preview image PV corresponding to such re-set contents. Then, the image forming apparatus 1 updates the preview image PV in the preview display region R1, and displays a screen GB3 (GB39) as shown in FIG. 36 on the touch screen 63. In the preview display region R1 of the screen GB39 (FIG. 36), not the preview image PV schematically showing “double-sided” but the preview image PV schematically showing “single-sided” is displayed. In such a way, the user UA can get to know the contents after the setting change.

As described above, the user UA is capable of searching and selecting the job JB1, which is similar to the job JB0 as the execution target, from the bookmark history information MA, and using “bookmark item” registered in the job JB1. Hence, the history information in the past can be used effectively.

Alternatively, in a similar way, in the case where the user UA executes the new job JB0, in the case where the user UA has got to know that a job JB2, which is similar to the new job and was executed in the past by another person (for example, the user UB), is present, the user UA is also capable of using bookmarks regarding the similar job JB2.

<Non-Display of Bookmark>

Moreover, in the above-described third embodiment or the like, the case has been illustrated, where the plurality of “bookmark item” is fixedly recorded in the image forming apparatus 1. However, in particular, when a large number of “bookmark item” is displayed on the menu image MN, it sometimes becomes difficult for the operator to find a desired option. Moreover, since an area of the bookmark display region R2 is restricted, a size of each “bookmark item” is reduced when the large number of “bookmark item” is attempted to be displayed.

Accordingly, a part of “bookmark item” is deleted based on “bookmark usage information”, whereby the menu image MN with such a restricted size can also be modified so as to be used more effectively. For example, based on the bookmark usage information MB, the bookmark registration unit 12 just needs to determine that “bookmark item” that satisfiers a predetermined condition among the plurality of bookmark items is “unnecessary bookmark item”, and to exclude the unnecessary bookmark item from display target items in the menu image MN (that is, bookmark items to be displayed in the menu image MN). Note that it is assumed below that the bookmark usage information MB is updated and recorded in the storage unit 5 for each execution of the job. Moreover, it is assumed here that an unnecessary bookmark deletion command (command to delete the unnecessary bookmark item) is given by an operation by the user, and that a deletion operation of “bookmark item” is executed in response to the unnecessary bookmark deletion command.

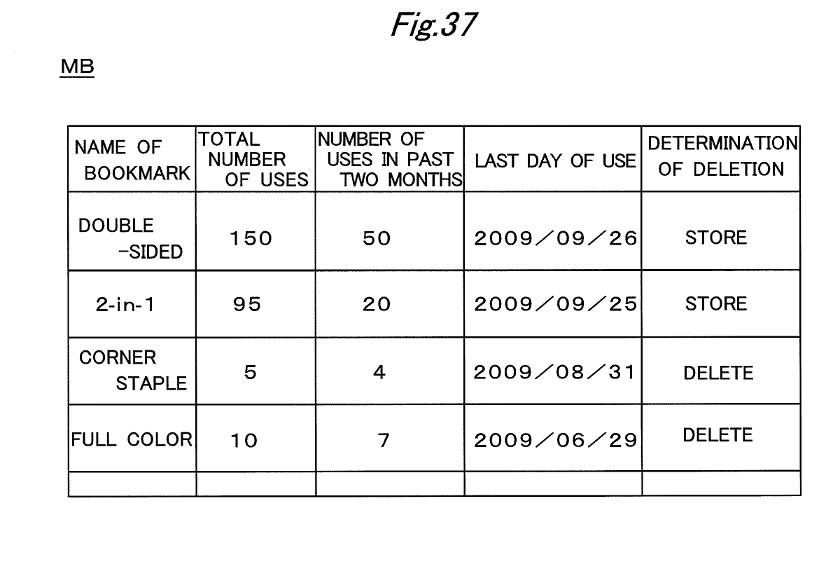

FIG. 37 is a view showing contents of a data table in which the bookmark usage information MB is recorded. As shown in FIG. 37, in this bookmark usage information MB, usage situations of the respective bookmark items in the past are shown. For example, with regard to “double-sided”, there are recorded: the total number of uses is “150”; the number of uses in the past two months is “50”; and the last day of use is “Sep. 26, 2009”.

Based on “bookmark usage information”, the image forming apparatus 1 searches and extracts “bookmark item”, which satisfies the predetermined condition, in response to the unnecessary bookmark deletion command given by the operation by the user. As the predetermined condition regarding “bookmark item”, for example, it is illustrated that either of conditions should be satisfied, which are: a condition “the number of uses in the past two months is five times or less”; and a condition “one month elapsed since the last day of use”, and so on.

In the bookmark usage information of FIG. 37, the number of uses of the bookmark item “corner staple” is four, and accordingly, the bookmark item “corner staple” satisfies the condition “the number of uses in the past two months is five times or less”. Therefore, the image forming apparatus 1 decides this bookmark item “corner staple” as one to be excluded (deleted) from the display target items. Moreover, if it is supposed that today is Sep. 26, 2009, then the bookmark “full color” satisfies the condition “one month elapsed since the last day of use” since the last day when the bookmark “full color” was used is Jun. 29, 2009. Therefore, the image forming apparatus 1 also decides this bookmark item “full color” as one to be excluded (deleted) from the display target items.

In FIG. 37, results of such determinations are described in the rightmost columns. Based on such determination results, two bookmark items which are “corner staple” and “full color” are excluded (deleted) from the display target items in the menu image MN. Meanwhile, the remaining items which are “double-sided” and “2-in-1”, which do not satisfy any of the above-described conditions, are maintained as the display target items in the menu image MN.

In accordance with this, among the plurality of “bookmark item”, the bookmark items which satisfy the predetermined condition (are determined to be unnecessary and) come not to be displayed in the menu image MN, and only the remaining “bookmark item” of which number is relatively small is displayed. Accordingly, the bookmark display region R2 (menu image MN) can be used effectively.

Note that, here, the case has been illustrated, where, in the case where the specific “bookmark item” satisfies the predetermined condition, it is only decided that the specific “bookmark item” should not displayed in the bookmark display region R2 (that the specific bookmark item should allowed not to be displayed), and the specific “bookmark item” is excluded (deleted) from the display target items while being left in the data table; however, the present invention is not limited to this. “Bookmark item” that satisfies the predetermined condition may be deleted from the data table itself of the image forming apparatus 1.

Moreover, here, the case where the unnecessary bookmark deletion command is given by the operation by the user has been illustrated; however, the present invention is not limited to this. For example, the image forming apparatus 1 may automatically execute such an exclusion operation as described above at predetermined periodic (or aperiodic) timing.

<Temporal Enlargement>

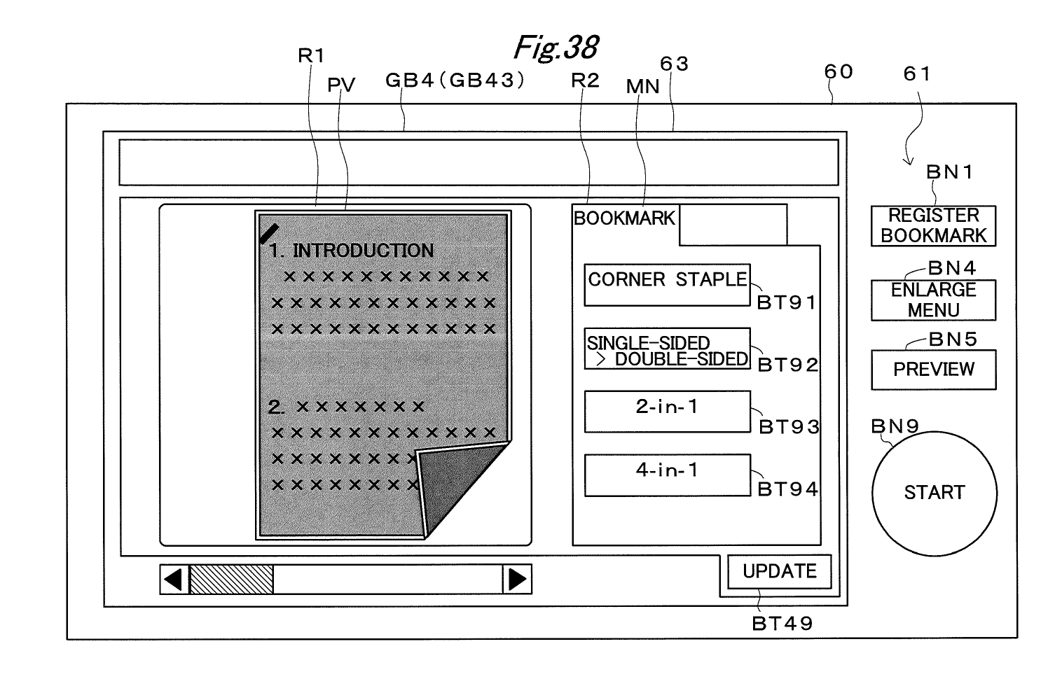

In each of the above-described embodiments, the case has been illustrated, where the menu image MN and the preview image PV are always displayed simultaneously in parallel to each other on the preview-added screen GB; however, the present invention is not limited to this. For example, in response to a pressing operation for a menu enlargement button BN4 (FIG. 38), the preview image PV may be temporarily deleted, and the menu image MN may be enlargedly displayed.

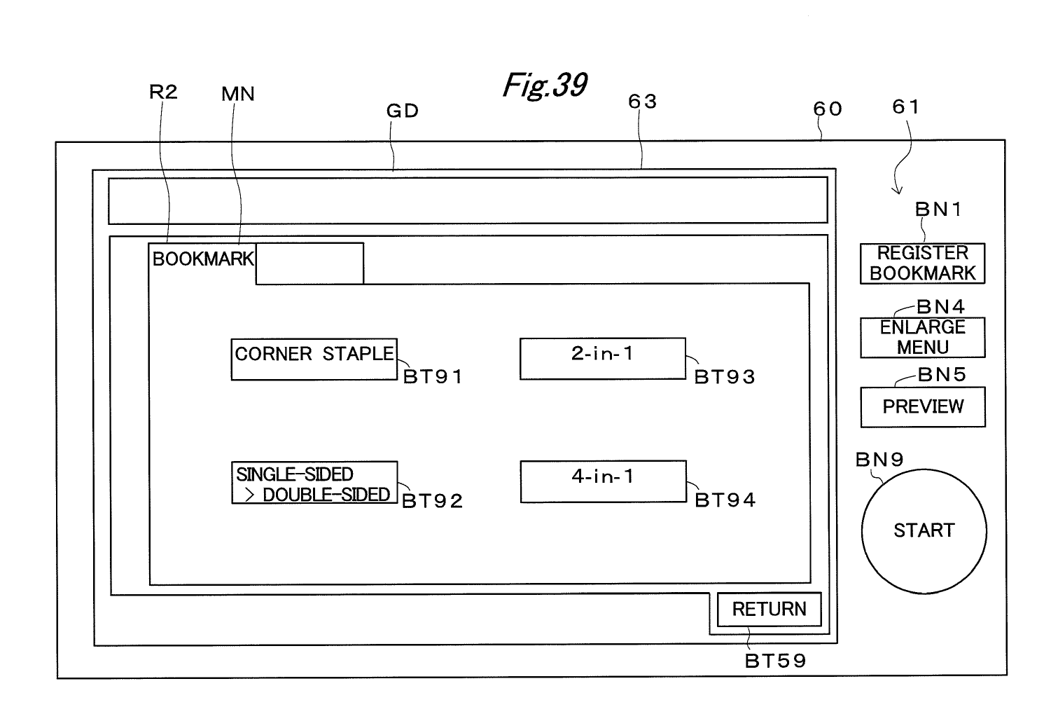

In detail, when the menu enlargement button BN4 is pressed down in a state where a preview-added screen GB4 (GB43) as shown in FIG. 38 is displayed, the image forming apparatus 1 may display a menu enlargement display screen GD (FIG. 39) on the touch screen 63 in place of the preview-added screen GB4. On the menu enlargement display screen GD, the preview image PV is not displayed, and in place of this, the menu image MN is enlarged, and is displayed over the substantially entire region of the touch screen 63. Note that, when a “return” button BT59 is pressed down, such a display state on the touch screen 63 returns to the original state of FIG. 38, where the preview-added screen GB4 is displayed. Moreover, in the case where the setting change is performed by using buttons BT91 to BT94 displayed in the enlarged menu image MN of FIG. 39, a preview image PV after the setting change (that is, a preview image PV on which re-setting contents are reflected) is displayed on the preview-added screen GB4 after the return.

In accordance with this, in the case where the user desires to temporarily enlarge and display the menu image, it is also possible satisfy such a desire.

<Others>

In each of the above-described embodiments, the description has been given of the copy job; however, the present invention is not limited to this. For example, the above-described idea can also be applied to the case of printing and outputting document data and the like, which are stored in a predetermined region (box) of the storage unit 5 of the image forming apparatus 1 (that is, the case of executing a so-called box printing job).

Moreover, in each of the above-described embodiments, the case has been illustrated, where the menu items regarding “bookmark item” itself or the lower hierarchies of “bookmark item” are displayed on the menu image MN or the like of the screen GB1; however, the present invention is not limited to this.

For example, it may also be made possible to display menu items regarding upper hierarchies of “bookmark item” on the menu image MN and the like of the screen GB1. In detail, in the case where “corner staple” is registered as the bookmark, when the “corner staple” button BT42 (FIG. 7) in the menu image MN of the screen GB1 is pressed down, an option to call up a menu item regarding the “staple” item located at a relatively upper hierarchy just needs to be also displayed in addition to the upper left button BT46, the upper right button BT47 and the release button BT48 in FIG. 8. It is assumed that a setting item of “two-point staple” in another item is also included in the “staple” item. In accordance with this, it is possible to easily execute many types of setting changes, that is, to easily expand a selection range in the setting changes.

Alternatively, it may also be made possible to display a menu item regarding the same hierarchy as that of “bookmark item” on the menu image MN and the like of the screen GB1. In detail, when the “corner staple” button BT42 (FIG. 7) in the menu image MN of the screen GB1 is pressed down, an option for another item “two-point staple” in the same hierarchy may also be displayed in addition to the buttons BT46 to BT48. Also in such a way, it is possible to easily execute many types of the setting changes.

While the invention has been shown and described in detail, the foregoing description is in all aspects illustrative and not restrictive. It is therefore understood that numerous modifications and variations can be devised without departing from the scope of the invention.

What is claimed is:

1. An image forming apparatus comprising:
a creation unit that creates a preview image showing a print output state regarding a target image of printing processing; and
an input/output unit that displays a screen including a preview display region which is a display region of the preview image and a re-set item display region which is a display region of a menu image having a setting item for re-set regarding the printing processing, and accepts a setting change input regarding the setting item for the re-set in the menu image,
wherein the creation unit recreates the preview image based on setting contents after a setting change, the setting contents being accepted with regard to the setting item for the re-set, and
the input/output unit displays the recreated preview image on the preview display region.

2. The image forming apparatus according to claim 1, further comprising:
a registration unit that registers, as the setting item for the re-set, a setting item of which setting contents are automatically decided in an automatic setting operation by the image forming apparatus.

3. The image forming apparatus according to claim 1, further comprising:
a registration unit that registers the setting item for the re-set for each job.

4. The image forming apparatus according to claim 3,
wherein the registration unit registers, as the setting item for the re-set, a setting item which has undergone mode setting in a mode setting operation regarding a processing target job.

5. The image forming apparatus according to claim 4,
wherein, among a plurality of setting items selected as the setting items for the re-set, the registration unit performs the mode setting for a first setting item, and registers the first setting item as the setting item for the re-set, and registers a second setting item competing with the first setting item as the setting item for the re-set without performing the mode setting for the second setting items.

6. The image forming apparatus according to claim 5,
wherein, among the plurality of setting items registered as the setting items for the re-set, the input/output unit displays the first setting item which has undergone the mode setting and the second setting item which has not undergone the mode setting, so as to be distinguished from each other.

7. The image forming apparatus according to claim 1,
wherein the setting item for the re-set is registered in advance before start of a processing target job.

8. The image forming apparatus according to claim 7,
wherein the setting item for the re-set is registered in advance before the start of the processing target job in response to command input by an administrator.

9. The image forming apparatus according to claim 7,
wherein the setting item for the re-set is decided for each user and is registered in advance.

10. The image forming apparatus according to claim 1, further comprising:
a storage unit that stores registration history information of the setting item for the re-set, the setting item being registered for each job,
wherein the input/output unit displays history information of a plurality of jobs included in the registration history information on a history information display screen, accepts designation input of a reference job as a job to be referred to among the plurality of jobs, and displays a certain setting item for re-set, the certain setting item being registered in the reference job, in the menu image.

11. The image forming apparatus according to claim 1, further comprising:
a registration unit that classifies and registers the setting item for the re-set in accordance with an expected usage frequency,
wherein the input/output unit classifies and displays a plurality of the setting items for the re-set in the menu image in accordance with expected usage frequencies.

12. The image forming apparatus according to claim 1, further comprising:
a registration unit that registers, as the setting item for the re-set, a specific setting item that is a setting item contributing to resource saving.

13. The image forming apparatus according to claim 12,
wherein the registration unit registers the specific setting item as the setting item for the re-set in response to predetermined operation input by a user.

14. The image forming apparatus according to claim 1,
wherein the input/output unit displays the menu image including a plurality of detail setting items regarding the setting item for the re-set, accepts at least one change input regarding the plurality of detail setting items in the menu image, and, in response to the at least one change input, updates and displays the preview image of which portions corresponding to the change inputs are updated.

15. The image forming apparatus according to claim 1, further comprising:
a registration unit that registers a plurality of setting items as the setting items for the re-set; and
a storage unit that stores usage information regarding the plurality of setting items,
wherein the registration unit excludes from a display target item in the menu image the setting item determined to satisfy a predetermined condition and to be unnecessary based on the usage information among the plurality of setting items.

16. An image forming method comprising the steps of;
a) creating a preview image showing a print output state regarding a target image of printing processing;
b) displaying a screen including a preview display region which is a display region of the preview image and a re-set item display region which is a display region of a menu image having a setting item for re-set regarding the printing processing;
c) accepting a setting change input regarding the setting item for the re-set in the menu image;
d) recreating the preview image based on setting contents after a setting change, the setting contents being accepted with regard to the setting item for the re-set; and
e) displaying the recreated preview image on the preview display region.

17. A computer-readable recording medium storing a computer program for performing the steps of;
a) creating a preview image showing a print output state regarding a target image of printing processing;
b) displaying a screen including a preview display region which is a display region of the preview image and a re-set item display region which is a display region of a menu image having a setting item for re-set regarding the printing processing;
c) accepting a setting change input regarding the setting item for the re-set in the menu image;
d) recreating the preview image based on setting contents after a setting change, the setting contents being accepted with regard to the setting item for the re-set; and
e) displaying the recreated preview image on the preview display region.
